(19) United States
(12) Patent Application Publication
(10) Pub. No.: US 2005/0213171 A1
(43) Pub. Date: Sep. 29, 2005

(54) Method of exposure recording on a planographic printing plate and an apparatus for practicing the method

(75) Inventor: Ichirou Miyagawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/090,181

(22) Filed: Mar. 28, 2005

(30) Foreign Application Priority Data
Mar. 29, 2004 (JP) 2004-96750

(51) Int. Cl. H04N 1/04

(52) U.S. Cl. 358/481

(57) ABSTRACT

A method of light exposure recording on a planographic printing plate, wherein the planographic printing plate includes a support and an image recording layer provided on the support, the image recording layer includes a radical polymerization initiator, the method comprising: irradiating the image recording layer with a predetermined amount of a first light, whereby the radical initiator generates a radical, the radical is quenched by free oxygen in the image recording layer, so that free oxygen in the image recording layer is exhausted and disappears from the image recording layer and that the image recording layer is supersensitized; and then rradiating the image recording layer with a second light as a recording light modulated on the basis of image information, so as to form a latent image corresponding to the image information on the image recording layer. Also provided is an apparatus for practicing the invention.

### CROSS-REFERENCE TO RELATED APPLICATION

This application claims priority under 35 USC 119 from Japanese Patent Application No. 2004-96750, the disclosure of which is incorporated by reference herein.

### BACKGROUND OF THE INVENTION

1. Field of the Invention

The present invention relates to a method of exposure recording an image on a planographic printing plate having a recording layer on a support. The method utilizes photo-radical polymerization reaction in image formation. The method utilizes the photon mode recording or the heat mode recording. The invention also relates to an apparatus for practicing the method.

2. Description of the Related Art

Generally, a photosensitive planographic printing plate (so-called PS plate) is utilized in offset printing. In the field of planographic printing, a planographic printing plate has been proposed which is used for a CTP (computer to plate) system. In the CTP system, a printing plate is made directly by being subjected to exposure with a laser based on digital data outputted from a computer etc.

As the planographic printing plate for the CTP system, there is a planographic printing plate for so-called photon mode recording and heat mode recording. The planographic printing plate has a photopolymerizable material layer as a photosensitive layer. The layer contains a monomer and a photo radical polymerization initiator capable of forming a radical when irradiated with light. The layer can initiate radical polymerization. The planographic printing plate for the photon mode recording or heat mode recording is still poor in sensitivity and requires a higher output of a laser as a light source. Therefore, there are needs for higher sensitivity in order to enable high-speed exposure and to reduce costs.

The planographic printing plate utilizing photo-radical polymerization reaction used the following image forming mechanism. The photopolymerizable material layer is exposed to laser recording light, whereby a radical generated from the radical initiator reacts with the monomer to make the monomer a radical which then reacts with another monomer. A polymer having a large molecular structure is formed through this reaction to form an image.

In the photo radical polymerization reaction carried out in the planographic printing plate, it is highly likely that the radical is quenched by oxygen present in the photopolymerizable material layer. Accordingly, the sensitivity of the planographic printing plate utilizing photo radical polymerization reaction is lowered by the existence of oxygen in the photopolymerizable material layer.

As illustrated in FIG. 5(A), an example of actually utilized planographic printing plate 10 has an aluminum support 12, an anodized film 14, a photopolymerizable image recording layer 16 provided on the anodized film 14, and a protective layer 18 as an oxygen-shielding layer provided on the surface of the image recording layer 16. The meaning of each numeral is the same in FIGS. 6(A), 6(B), and 8(A). Even in the planographic printing plate 10, oxygen penetrates into and dissolves in the image recording layer 16 and the protective layer 18 to the saturation state during a long period between the production and use.

When such the planographic printing plate 10 is subjected to exposure by irradiation with laser light from a laser exposure device 20 as shown in FIGS. 6(A) and 6(B), radicals generated in the image recording layer 16 are quenched by oxygen dissolved to the saturated state in the image recording layer 16 during the period between the time point T0 and the time point T1 (shown in FIG. 5(B)). T0 is the time point at which irradiation is initiated. Thus, the radical polymerization of the monomer does not proceed. Rather, radical molecules generated continuously by irradiation of the image recording layer 16 with laser light undergo addition reaction with oxygen molecules, to form peroxides. The peroxides then react with hydrogen radicals to form inactive peroxides. Only after the time point T1 (shown in FIG. 5(B)) at which oxygen molecules have been depleted in the image recording layer 16 through the above reaction, the polymerization reaction rapidly progresses.

As shown in FIG. 5(B), the polymerization reaction thus initiated approaches the upper limit of the reaction rapidly while oxygen is prevented from entering the image recording layer 16. Therefore, the polymerization reaction in the image recording layer 16 reaches a plateau.

When the planographic printing plate 10 is exposed, the oxygen concentration in the image recording layer 15 rapidly decreases during a period between T0 and T1, as shown in FIG. 7. Only during a certain period after the initiation of radical polymerization, the oxygen concentration is nearly zero because of the oxygen-shielding action of the protective layer 18. After a certain point in time, the oxygen concentration slightly increases.

As illustrated in FIG. 8(A), there is a planographic printing plate not having a protective layer 18. Oxygen can easily dissolve in the image recording layer 16, so that the image recording layer 16 is not exposed even under slight light upon handling of the planographic printing plate 10.

In the planographic printing plate 10, oxygen dissolves in the image recording layer 16 and the protective layer 18 to the saturation state in a period between the production and use.

As shown in FIG. 5(B), the polymerization reaction thus initiated approaches the upper limit of the reaction rapidly while oxygen is prevented from entering the image recording layer 16. Therefore, the polymerization reaction in the image recording layer 16 reaches a plateau.

When such the planographic printing plate 10 is subjected to exposure by irradiation with laser light, radicals generated in the image recording layer 16 are quenched by oxygen dissolved to the saturated state in the image recording layer 16 during the period between the time point T0 and the time point T1 (shown in FIG. 8(B)). T0 is the time point at which irradiation is initiated. Thus, the radical polymerization of the monomer does not proceed. Rather, radical molecules generated continuously by irradiation of the image recording layer 16 with laser light undergo addition reaction with oxygen molecules, to form peroxides. The peroxides then react with hydrogen radicals to form inactive peroxides. Only after the time point T1 (shown in FIG. 8(B)) at which oxygen molecules have been depleted in the image recording layer 16 through the above reaction, the polymerization reaction rapidly progresses.

As shown in FIG. 8(B), the polymerization reaction thus initiated approaches the upper limit of the reaction gradually because of the absence of the protective layer 18 preventing oxygen from entering the image recording layer 16.

There is a conventional method for producing a printing plate disclosed, for example, in Japanese Patent Application Laid-Open (JP-A) No. 9-197655. In the method, the sensitivity is secured by the constitution described below. In the exposure of a printing plate precursor having a photopolymerizable layer containing a compound having an ethylenically unsaturated bond and a photopolymerization initiator, a transparent sheet larger than the printing plate precursor is placed over the precursor in order to suppress reaction inhibition caused by oxygen. Further, for the purpose of realizing an environment of low oxygen and achieving the adhesiveness of the sheet, the printing plate is placed on a member having a plurality of suction holes and subjected to imagewise exposure under evacuation through the suction holes.

In the conventional method of forming a printing plate, however, radials are quenched by oxygen (dissolved to a saturated state) in the photopolymerizable layer in the period between the production and use. Therefore, even if an environment of dilute oxygen is realized by placing the transparent sheet larger than the printing plate precursor, the radical polymerization reaction hardly proceeds continuously before a large amount of oxygen in the photopolymerizable layer is exhausted. Consequently, the sensitivity of the planographic printing plate 10 is low in the conventional method.

### SUMMARY OF THE INVENTION

The present invention provides a method of exposure recording on a planographic printing plate. The method comprises conducting exposure while maintaining a low oxygen content in the image recording layer on the support. The method realizes high sensitivity. The present invention also provides an apparatus for practicing the method of the invention.

A first aspect of the invention is to provide a method for light exposure recording on a planographic printing plate. The planographic printing plate includes a support and an image recording layer provided on the support. The image recording layer utilizes photo-radical polymerization reaction for image formation. The method comprises: irradiating the image recording layer with a predetermined amount of a first light; and then irradiating the image recording layer with a second light as recording light modulated on the basis of image information, so as to form a latent image corresponding to the image information on the image recording layer. In the first irradiation, a radical initiator generates a radical and free oxygen in the image recording layer quenches the radical, whereby free oxygen in the image recording layer is exhausted and the image recording layer is supersensitized.

According to the above method, the sensitivity of the image recording layer is improved by depleting the oxygen in the image recording layer, then the highly sensitive image recording layer is irradiated with a second light (recording light) modulated on the basis of image information, to form a latent image corresponding to the image information on the image recording layer. Since free oxygen does not remain in the supersensitized image recording layer, no recording light (second light) is quenched by the reaction between the radical and oxygen, and nearly all of the recording light is used for initiating radical polymerization to record an image on the image recording layer. Therefore, the amount of light required for forming image by scan exposing the image recording layer of the planographic printing plate is relatively small. Thus, the output of the exposure light source device can be relatively low and use of an expensive high-power light source is unnecessary, resulting in the reduction of the cost of the light source.

The second aspect of the invention is to provide an exposure recording apparatus for a planographic printing plate including a support and a photo-radical polymerizable image recording layer provided on the support. The apparatus includes a pre-exposure lighting device and an exposure head. The image recording layer is irradiated with a predetermined amount of the first light emitted by the pre-exposure lighting device, whereby the radical initiator in the image recording layer generates a radical, and the radical is quenched by oxygen in the image recording layer such that free oxygen does not remain in the image recording layer. Through this mechanism, the image recording layer irradiated with the first light is supersensitized. The exposure head emits the second light (recording light) modulated on the basis of image information, and a latent image corresponding to the image information is formed on the image recording layer irradiated with the second light.

When this exposure recording apparatus is used, the sensitivity of the image recording layer is improved by depleting the oxygen in the image recording layer, then the highly sensitive image recording layer is irradiated with second light (recording light) modulated on the basis of image information, to form a latent image corresponding to the image information on the image recording layer. The oxygen is depleted by the irradiation of the recording layer with the first light emitted by the pre-exposure lighting device, the irradiation generating a radical in the image recording layer which is then quenched by oxygen. Since free oxygen does not remain in the supersensitized image recording layer, no recording light (second light) is quenched by the reaction between the radical and oxygen, and nearly all of the recording light is used for initiating radical polymerization to record an image on the image recording layer. Therefore, the amount of light required for forming image by scan exposing the image recording layer of the planographic printing plate is relatively small. Thus, the output of the exposure light source device can be relatively low and use of an expensive high-power light source is unnecessary, resulting in the reduction of the cost of the light source. Further, since the pre-exposure lighting device can be any light source capable of uniformly irradiating a predetermined area, and a light source with a simple constitution can be used. Therefore, the exposure recording apparatus for the planographic printing plate can be produced inexpensively.

### BRIEF DESCRIPTION OF THE DRAWINGS

FIGS. 1(A) to 1 (E) are explanatory diagrams showing the models of a planographic printing plate in respective processes of the exposure recording method of an embodiments of the invention.

FIG. 2 is an enlarged perspective view of essential parts of the exposure recording apparatus of an embodiment of the invention, illustrating the pre-exposure lighting device and the exposure head.

FIG. 3 is a schematic side view of essential parts of the exposure recording apparatus of an embodiment of the invention, illustrating the oxygen exhausting section and the exposure section.

FIG. 4 is an enlarged perspective view of essential parts of the exposure recording apparatus of an embodiment of the invention, illustrating a long irradiation head as the pre-exposure lighting device and the exposure head.

FIG. 5(A) is a schematic diagram illustrating an exemplary model of a conventional planographic printing plate having a protective layer on an image recording layer and containing oxygen.

FIG. 5(B) is a graph showing the degree of polymerization upon exposure of the oxygen-containing conventional planographic printing plate.

FIGS. 6(A) and 6 (B) are explanatory diagrams illustrating exposure of a conventional planographic printing plate whose image recording layer under a protective layer contains oxygen.

FIG. 7 is a graph showing a change in oxygen concentration upon exposure of a conventional planographic printing plate whose image recording layer under a protective layer contains oxygen.

FIG. 8(A) is a schematic diagram illustrating an exemplary model of a conventional planographic printing plate containing oxygen but having no protective layer.

FIG. 8(B) is a graph showing the degree of polymerization upon exposure of the oxygen-containing conventional planographic printing plate having no protective layer.

### DETAILED DESCRIPTION OF THE INVENTION

The method of exposure recording of an embodiment of the invention for a planographic printing plate, and the apparatus for practicing this method will be described in detail with reference to the drawings.

(Method of Exposure Recording Involving Supersensitization of the Image Recording Layer of a Planographic Printing Plate)

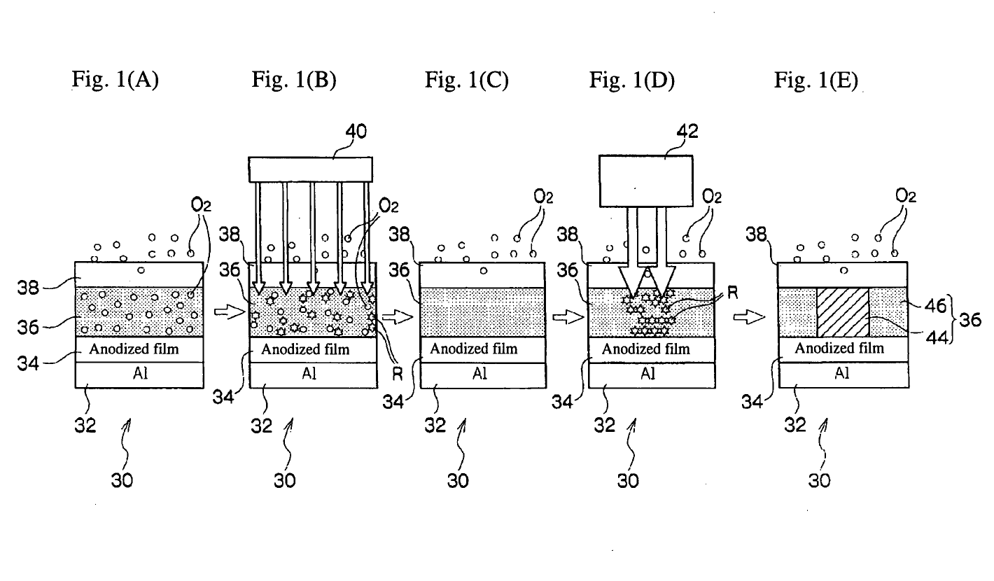

First, the exposure recording method for a planographic printing plate will be described in detail with reference to FIG. 1.

The exposure recording method can be applied to a photon-mode or heat-mode planographic printing plate which utilizes a general photo-radical polymerization reaction.

As shown in the model of essential parts illustrated in FIG. 1, a planographic printing plate 30 (a radical-polymerization type planographic printing plate) utilizing a photo radical polymerization reaction has a multi-layer structure comprised of an aluminum support 32, an anodized film 34, an image recording layer 36, and a protective layer 38, the layers being laminated in this order.

An image can be formed on the image recording layer 36. The mechanism of image formation is as follows: when laser exposure is conducted on the photopolymerizable material, a radical is generated by a radical initiator and reacts with a monomer to convert the monomer into a radical which then reacts with another monomer thereby forming a polymer having a large molecular structure through repetition of this reaction.

The protective layer 38 is an oxygen-shielding layer to prevent oxygen in the air from dissolving in the image recording layer 36.

In the radical-polymerization-type planographic printing plate 30 having the above constitution, oxygen dissolves in the image recording layer 36 and the protective layer 38 usually to the saturation during a period between the production and use, as illustrated in FIG. 1(A).

In the exposure recording method of an embodiments of the invention comprising supersensitizing the image recording layer of a planographic printing plate and then conducting exposure, a pre-exposure lighting device 40 radiates a predetermined amount of a first light capable of causing a radical initiator to generate a radical, the radical is then quenched by oxygen in the image recording layer 36 so that oxygen disappears from the image recording layer, thus suppressing the inhibition of radical polymerization reaction by oxygen, as shown in FIG. 1(B).

The pre-exposure lighting device used as described above is a light capable of uniformly irradiating the region (to be exposed) of the image recording layer 36 of the planographic printing plate 30 just before the exposure. Accordingly, the pre-exposure lighting device 40 may be a lamp capable of uniformly irradiating a predetermined area with light whose spectrum includes a wavelength capable of causing the radical initiator to generate a radial.

Conditions such as light wavelength, light quantity (light intensity) and irradiation time at irradiation of the image recording layer 36 with the first light from the pre-exposure lighting device 40 may be determined in accordance with the chemical composition of the image recording layer 36 to be irradiated, the amount of oxygen molecules dissolved in a saturated state in the image recording layer 36, or the like. Therefore, the conditions may be determined experimentally for each type of image recording layer 36 prior to the irradiation of the first light, and the conditions suitable for the image recording layer 36 to be actually exposed may be selected.

Upon irradiation of the image recording layer 36 of the planographic printing plate 30 with light of predetermined conditions from the pre-exposure lighting device 40, continuously generated radical molecules undergo addition reaction with oxygen molecules to form peroxides which then react with hydrogen radicals to form inactive hydrogen peroxides. Through such reactions, the oxygen molecules in the image recording layer 36 are consumed and exhausted, thus achieving a supersensitized state of the image recording layer 36 as shown in FIG. 1(C). When the image recording layer 36 is irradiated with the first light radiated by the pre-exposure lighting device 40, the sensitivity of the image recording layer 36 can be heightened to two or three times the original sensitivity.

In the exposure recording method of the embodiment of the invention, the supersensitized image recording layer 36 of the planographic printing plate 30 precursor is subjected to scanning exposure with an infrared laser light (referred to hereinafter as “IR laser L”) modulated on the basis of digital image information. The IR laser L is the recording light (second light) radiated from an exposure head 42. This process is illustrated in FIG. 1(D). By the scanning exposure, an image (latent image) corresponding to the digital image information is formed on the image recording layer 36.

Upon irradiation of the image recording layer 36 with the recording laser light from the exposure head 42, radical R is generated in the image recording layer 36 to immediately initiate the radical polymerization reaction of a monomer, and this polymerization reaction is continuously caused to form a polymer 44. The region having the polymer 44 formed by the recording light (second light) constitutes a latent image. A region 46 of the image recording layer 36 which was not exposed to the recording light (second light) is dissolved by separately conducting the development of the planographic printing plate 30, to form an image formed by the polymer 44.

In this exposure step, free oxygen does not remain in the supersensitized image recording layer 36, and thus a part of the recording light (second light) is not consumed for the generation of a number of radicals which is nearly the same as the number of radicals that the oxygen included in the image recording layer 36 before exposed to the first light can quench. Therefore, approximately the entire recording light (second light) is used for initiating the radical polymerization reaction and recording an image on the image recording layer 36.

In other words, in this method, the first light works as a replacement for the part of the recording light (second light) which could not be used for exposure because of the existence of oxygen in the image recording layer 36 if the exposure were conducted only with the recording light from the exposure head 42 as in conventional methods. The irradiation with the first light is conducted such that the number of radicals generated by the first light is approximately the same as the number of radicals that the oxygen in the recording layer prior to the irradiation with the first light can quench. The image recording layer of the planographic printing plate is supersensitized in this way.

(Apparatus for Practicing The Exposure Recording Method which Involves Supersensitization of an Image Recording Layer of a Planographic Printing Plate)

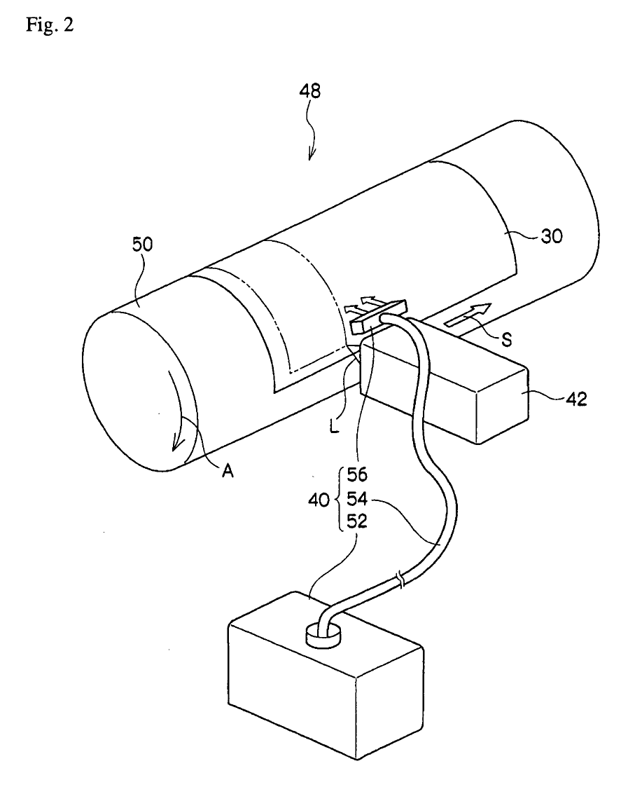

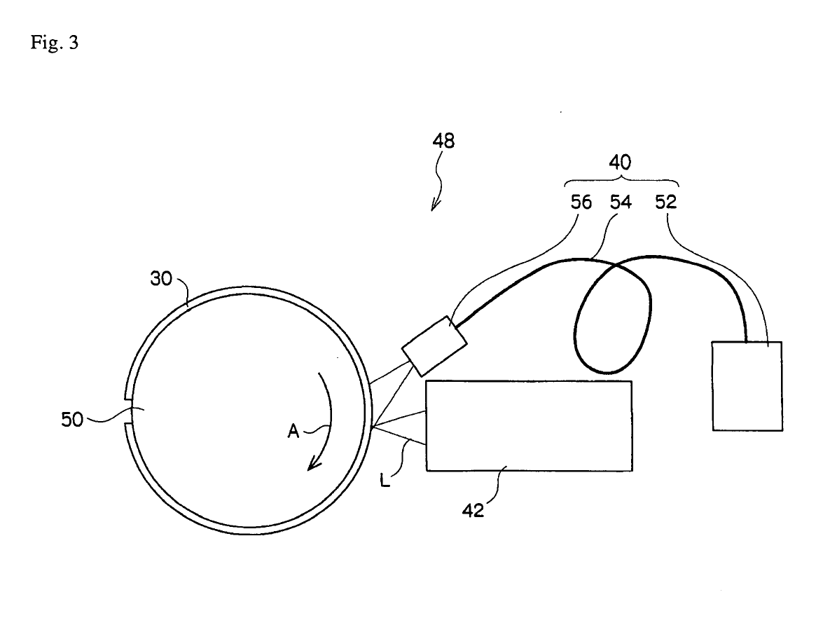

In the following, the apparatus for practicing the above exposure recording method (comprising supersensitizing the image recording layer of a planographic printing plate and exposing the image recording layer) is described in detail with reference to FIGS. 2 and 3.

An embodiment of the invention is to provide an image forming apparatus which utilizes the above exposure recording method (comprising supersensitizing the image recording layer of a planographic printing plate and exposing the image recording layer). The image forming apparatus 48 shown in FIGS. 2 and 3 is an example of the image forming apparatus. Essential parts of the image forming apparatus 48 are shown in FIGS. 2 and 3. The image forming apparatus 48 (setter) includes a pre-exposure lighting device 40 capable of conducting the above irradiation with the first light and an exposure head 42 capable of conducting laser recording.

The image forming apparatus 48 has an outer drum 50 in a cylindrical form. The outer drum 50 can retain a planographic plate. The outer drum 50 can be rotated and can transfer the planographic printing plate 30 in the main scanning direction (the direction indicated by the arrow A). The planographic printing plate 30 is placed on the outer drum 50, but detachable from the outer drum 50.

The planographic printing plate 30 is held detachably by the outer periphery of the outer drum 50. In order to hold the planographic printing plate 30, the outer drum 50 has a chucking mechanism (chucking devices, not shown in the figure) thereon, and the top and rear end of the planographic printing plate 30 are held by their corresponding chucking devices, such that the planographic printing plate 30 is held on the outer drum 50.

In the image forming apparatus 48, the pre-exposure lighting device 40 is arranged upstream of the exposure head 42 with respect to the main scanning direction (direction indicated by the arrow A in the figure).

The pre-exposure lighting device 40 comprises a light source 52, an optical fiber 54, and a light-projecting irradiation head 56. The light-projecting irradiation head 56 is attached to the end of the optical fiber 54 connected to the light source 52.

The light source 52 has a general infrared lamp, xenon lamp or the like therein. In the pre-exposure lighting device 40, the first light emitted by the infrared lamp or the like is collected, and directed to the incident terminal of the optical fiber 54, transmitted through the optical fiber 54, and sent to the irradiation head 56. The spectrum of the first light has to include the wavelength capable of causing a radical initiator to generate a radical. In the irradiation with the first light, the conditions of light emitted from the light source 52, such as light wavelength, light quantity (light intensity) and irradiation time, should be varied depending on the chemical composition of the image recording layer 36 to be irradiated, the amount of oxygen molecules dissolved in a saturated state in the image recording layer 36, etc.,. Thus, the light emission is controlled in accordance with the conditions for each type of image recording layer 36 experimentally determined in advance.

The irradiation head 56 in the pre-exposure lighting device 40 is such an irradiation head that a predetermined area on the image recording layer 36 of the planographic printing plate 30 is irradiated uniformly with the light emitted by the light source 52 and transmitted through the optical fiber 54. The planographic printing plate 30 is irradiated with the first light preferably immediately before the exposure to the second light.

In supersensitizing the image recording layer 36 by irradiation with the first light from the illumination head 56, the image recording layer 36 should have identical sensitivity (identical oxygen distribution) over a region to be exposed to the second light from the exposure head 42. This is because when there is unevenness of sensitivity on the image recording layer 36, a predetermined image cannot be suitably formed. Accordingly, uniform sensitivity over the entire surface of the image recording layer 36 is necessary.

The exposure head 42 of the image forming apparatus 48 is used for scanning exposure of the planographic printing plate (precursor) 30 with an infrared laser light modulated on the basis of digital image information. By the scanning exposure, an image (latent image) corresponding to the digital image information is formed on the planographic printing plate (precursor) 30.

The exposure head 42 faces the outer drum 50. A transfer mechanism (not shown) moves the exposure head 42 together with the irradiation head 56 in the sub scanning direction.

In the image forming apparatus 48, the outer drum 50 retains the planographic printing plate 30. The irradiation head 56 integrated with the exposure head 42. The irradiation head 56 and the exposure head 42 scan the planographic printing plate 30 in the main scanning direction owing to the rotation of the outer drum 50 while scanning the planographic printing plate 30 in the sub scanning direction by moving in the sub scanning direction. By this constitution, the planographic printing plate is exposed immediately after irradiated with the first light.

As described above, in the image forming apparatus 48, the outer drum 50 retains the planographic printing plate 30. The irradiation head 56 and the exposure head 42 scan the planographic printing plate 30 in the main scanning direction owing to the rotation of the outer drum 50 while scanning the planographic printing plate 30 in the sub scanning direction by moving in the sub scanning direction. By this constitution, the planographic printing plate is exposed immediately after irradiated with the first light. However, the constitution is not limited to the above constitution, and other constitutions (not shown in the figures) may be selected. In an exemplary embodiment, the image forming apparatus has the following constitution: the planographic printing plate 30 is held by an immobile holding member (other than the outer drum); the irradiation head 56 and the exposure head 42 are moved in the main scanning direction and in the sub scanning direction to scan the planographic printing plate; thus the planographic printing plate is exposed immediately after the irradiation with the first light. In another exemplary embodiment, the image forming apparatus has the following constitution: the irradiation head 56 and the exposure head 42 are immobile; the planographic printing plate 30 is held by a holding member capable of moving in the main scanning direction and in the sub scanning direction; the planographic printing plate 30 held by the holding member is moved in the main scanning direction and in the sub scanning direction so as to be scanned by the irradiation head 56 and the exposure head 42; thus the planographic printing plate is exposed immediately after the irradiation with the first light. In another exemplary embodiment, the image forming apparatus has the following constitution: a holding member holding the planographic printing plate 30 is moved in the sub scanning direction while the irradiation head 56 and the exposure head 42 are moved in the main scanning direction, so that the irradiation head 56 and the exposure head 42 scan the planographic printing plate 30, thus the planographic printing plate is exposed immediately after the irradiation with the first light.

Although not shown in the figure, in an embodiment, the exposure head 42 is constituted such that: a plurality of optical fibers are connected to an LD light source; the light, for example the NIR laser L, transmitted by the optical fibers is focused on the planographic printing plate (precursor) 30 held by the outer drum 50 by a lens unit (as an image-forming optical system) so that the planographic printing plate precursor is exposed to beam spot having a predetermined shape and size.

In the image forming apparatus 48, the planographic printing plate 30 is subjected to exposure after the image recording layer 36 is supersensitized to have a sensitivity which is two times the sensitivity prior to the supersensitization. Therefore, the latent image can be formed by scan-exposing the planographic printing plate (precursor) 30 to laser light (for example NIR laser L) of relatively low laser power (light quantity for exposure). Accordingly, the output power of the LD light source device for the exposure head 42 can be relatively low, and thus the LD light source device can be produced inexpensively without using an expensive high-power LD light source.

The exposure head 42 and irradiation head 56 are mounted on, and integrated with, a carrier in a transfer mechanism not shown in the figure such that they are transferred in the sub scanning direction (direction indicated by arrow S in FIG. 2).

Although not shown in the figure, in an embodiment, this transfer mechanism is composed of a pair of guide rails supporting the carrier such that the carrier can be slid in the sub scanning direction and a feed screw axis connected to a motor unit. In this embodiment, a female screw member in a block form is fixed to a lower surface of the carrier, and the screw axis is screwed into a female screw hole bored in the female screw member.

In the above transfer mechanism, the rotation of the screw axis is controlled by the motor unit, whereby the irradiation head 56 and exposure head 42 integrated with the carrier are moved (under control) a distance corresponding to the rotation of the screw axis in the direction (forward or backward direction along the sub scanning direction) corresponding to the rotation direction of the screw axis. In this constitution, the transfer mechanism moves both the irradiation head 56 and exposure head 42, and thus the number of members can be reduced to simplify the constitution. In another embodiment, the irradiation head 56 and exposure head 42 are moved (under control) independently by separate transfer mechanisms.

Although not shown in the figure, the image forming apparatus 48 may also have a transportation apparatus which can feed the planographic printing plate 30 to the outer drum 50 and can take the planographic printing plate 30 out of the outer drum 50.

In the image forming apparatus 48, the planographic printing plate (precursor) 30 held by the outer drum 50 is subjected to scanning exposure to e.g. NIR laser L modulated on the basis of digital image information immediately after the irradiation with the first light, whereby a latent image corresponding to the digital image information is formed on the image recording layer of the planographic printing plate (precursor) 30.

The planographic printing plate 30 having the latent image is then developed and completed as the planographic printing plate 30 having the image. The planographic printing plate 30 having the image is attached to a printing machine (not shown) and subjected to printing.

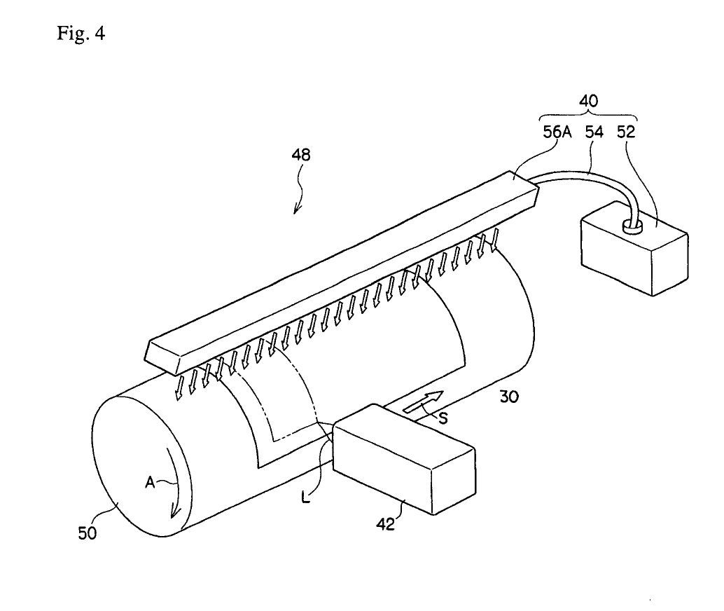

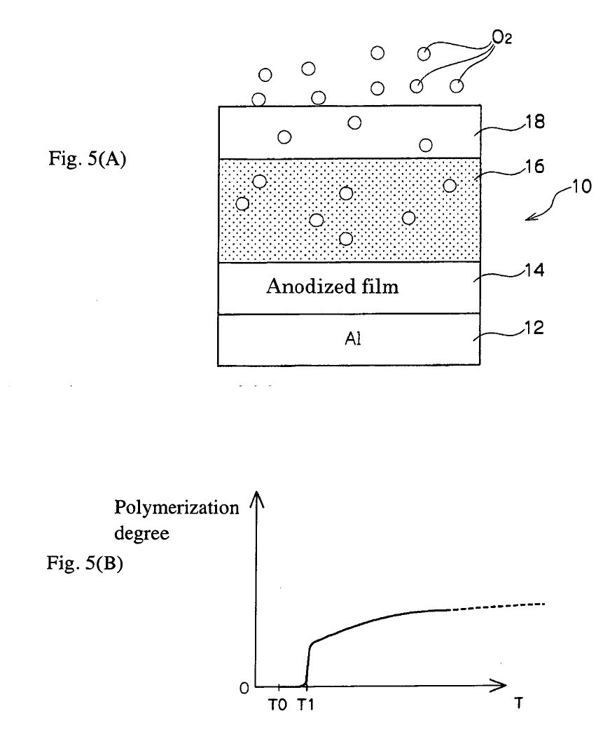

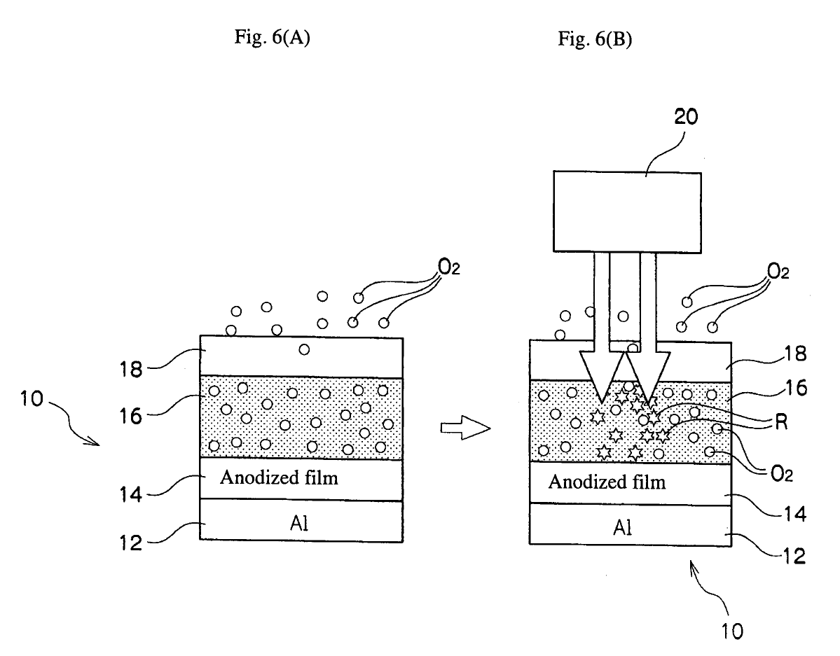

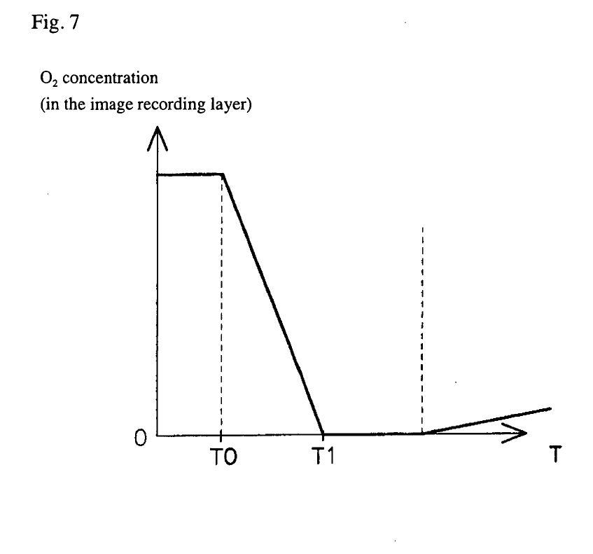

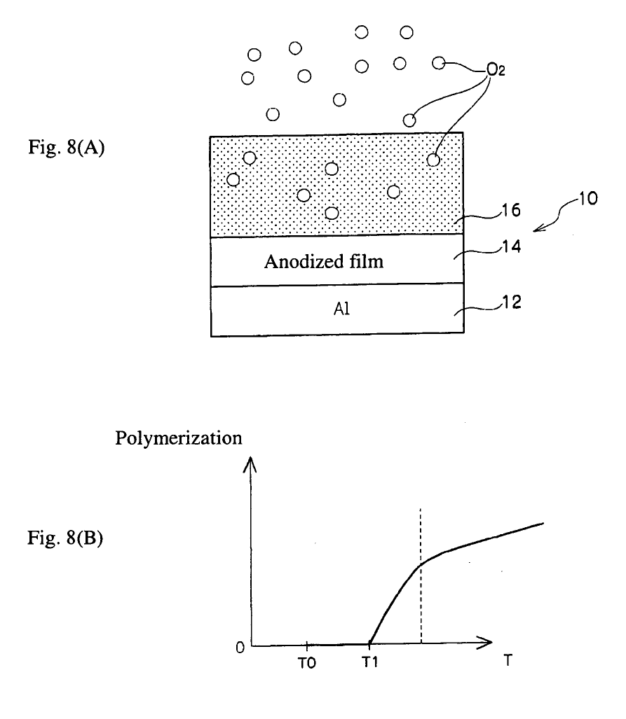

In the following, another example of the apparatus is described in detail with reference to FIG. 4, which apparatus can practice the exposure recording method which comprises supersensitizing the image recording layer of a planographic printing plate and then exposing the image recording layer.

In the constitutional example of the apparatus shown in FIG. 4, the image recording layer 36 of the planographic printing plate 30 is exposed only after irradiation of the entire surface of the image recording layer 36 with the first light is completed.

In this constitution, the long irradiation head 56A in the pre-exposure lighting device 40 can uniformly irradiate the planographic printing plate 30 on the outer drum 50 with light sent through the optical fiber 54 from the light source 52. The long irradiation head 56A can uniformly irradiate an area on the outer drum 50, wherein the maximum width of the planographic printing plate 30 is covered by the width of the area, and the term “width” used in this sentence refers to the direction on the outer drum 50 which direction is perpendicular to the main scanning direction.

In the exemplary apparatus constitution shown in FIG. 4, the entire surface of the image recording layer 36 of the planographic printing plate 30 is irradiated with a predetermined amount of the first light emitted by the long irradiation head 56A while the outer drum 50 is rotated in the main scanning direction (direction indicated by arrow A in the figure). The predetermined amount of the first light causes a radical initiator to generate a radical, then the radical is quenched by oxygen in the recording layer, so that oxygen disappears from the recording layer. By the irradiation, the inhibition of radical polymerization reaction by oxygen is prevented and the image recording layer is supersensitized.

In the exemplary apparatus constitution shown in FIG. 4, the exposure is started only after the pre-exposure lighting device 40 is stopped to terminate the irradiation with the first light. In the exposure, the planographic printing plate (precursor) 30 held by the outer drum 50 is subjected to scanning exposure to e.g. NIR laser L which is radiated from the exposure head 42 and which is modulated on the basis of digital image information. By the scanning exposure, a latent image corresponding to the digital image information is formed on the image recording layer of the planographic printing plate (precursor) 30. The direction of the movement of the exposure head 42 is shown by an arrow S in FIG. 4.

In an exemplary embodiment of the apparatus constitution shown in FIG. 4, only a region to be exposed immediately on the image recording layer 36 of the planographic printing plate 30 is uniformly irradiated, as in the case of the apparatus shown in FIGS. 2 and 3.

In this case, the first light is emitted only from portions in the longitudinal direction of the long irradiation head 56A, the portions corresponding to the portions which require irradiating on the planographic printing plate. Therefore, the first light is radiated selectively to the portions (corresponding to the region to be irradiated with the irradiation head 56 shown in FIGS. 2 and 3). The portions on the planographic printing plate have not been exposed, and are to be exposed immediately. As a result of the selective irradiation, only in the portions on the image recording layer 36 are irradiated with the first light to generate a radical, then the radical is quenched by oxygen in the recording layer, so that oxygen disappears from the recording layer. By the selective irradiation, the inhibition of radical polymerization reaction by oxygen is prevented only in the irradiated portions.

In the exemplary apparatus constitution shown in FIG. 4, the image recording layer 36 of the planographic printing plate 30 immediately after the exposure treatment may be subjected to a further post-exposure treatment. In the treatment, the oxygen entering the image recording layer 36 immediately after the exposure with the exposure head 42 is consumed for the quenching of the radicals generated by the post-exposure treatment. Therefore, the oxygen is prevented from remaining in the recording layer, thus suppressing the inhibition of radical polymerization reaction by the oxygen and causing the polymerization reaction continuously to realize a sufficient polymerization degree.

If it takes tens of seconds for the monomer to radical polymerize to cure upon the exposure of the image recording layer 36, oxygen newly enters the image recording layer 36 within the period. In that case, the oxygen enters the image recording layer 36 while the radical polymerization is still in progress, whereby the proceeding of the radical polymerization reaction is inhibited and formation of an appropriate latent image is inhibited by the oxygen. The post-exposure treatment can solve the problems.

In the post-exposure treatment, a required amount of a third light is radiated only to portions on the image recording layer 36 of the planographic printing plate 30. The portions are portions which has just been exposed and in which the radical polymerization is still in progress. The required amount of the third light is an amount of light which produces a number of radicals which is nearly the same as the number of radicals that the newly entering oxygen can quench.

In an embodiment of the apparatus constitution shown in FIG. 4, the irradiation head 56A uniformly radiates a required amount of the third light only to portions on the image recording layer 36, so that an appropriate image can be formed. The portions are portions which has just been exposed and in which the radical polymerization is still in progress. The required amount of the third light is an amount of light which produces a number of radicals which is nearly the same as the number of radicals that the oxygen newly entering the image recording layer 36 can quench.

When the second light and third light are controlled separately, the existence of free oxygen is more effectively prevented.

The other constitutions, actions and effects of the exemplary apparatus constitution shown in FIG. 4 are the same as in the case of the apparatus shown in FIGS. 2 and 3 described above. Thus, the explanations about those things are omitted from the explanation of the apparatus constitution of FIG. 4.

In the embodiments of the invention described above, the planographic printing plate 30 having the protective layer 38 arranged on the surface of the image recording layer 36 has been described. However, the exposure recording method of the invention and the apparatus for practicing this method can also be applied to the planographic printing plate 30 which does not have the protective layer 38 on the image recording layer 36. The effect of the invention is expected to be remarkable if the planographic printing plate 30 does not have the protective layer 38 on the image recording layer 36 because oxygen easily enters the image recording layer 36.

(Planographic Printing Plate Utilizing Photo Radical Polymerization Reaction)

The following description relates to the details of the method of exposure recording on a planographic printing plate according to the embodiments of the invention and the planographic printing plate utilizing a photo radical polymerization reaction which can be used in the apparatus for practicing the method.

The planographic printing plate utilizing a photo radical polymerization reaction may be sensitive to a wavelength region within the wavelength region from UV to near infrared. The wavelength region to which the planographic printing plate is sensitive can be controlled by selecting an appropriate photopolymerization initiator. The planographic printing plate can be classified by the development method and may be classified into alkali development type and on-press development type. Specifically, the following planographic printing plates can be exemplified:
NIR (recording light wavelength 760 to 1200 nm) on-press development-type planographic printing plate
NIR (recording light wavelength 760 to 1200 nm) alkali development-type planographic printing plate
UV (recording light wavelength 250 to 420 nm) on-press development-type planographic printing plate
Visible (recording light wavelength 400 to 700 nm) alkali-type planographic printing plate

Hereinafter, each type of planographic printing plate is described in more detail.

(1) NIR (Near Infrared) On-Press Development-Type Planographic Printing Plate

[Planographic Printing Plate Precursor]

<Image Recording Layer>

The planographic printing plate precursor of the invention includes, on a support, an image recording layer including (A) an infrared absorbing agent, (B) a polymerization initiator, (C) a polymerizable compound and (D) a binder polymer and the image recording layer is capable of recording by irradiation with infrared rays.

In this planographic printing plate precursor, a portion of the image recording layer which portion is exposed to infrared light is cured to form a hydrophobic (lipophilic) region. When printing is initiated, a region which has not been exposed to the infrared light is rapidly removed from the support by application of moistening water, ink, or an emulsion of ink in moistening water. That is, the image recording layer is an image recording layer removable with printing ink and/or moistening water. Hereinafter, the respective components of the image recording layer are described in detail.

<(A) Infrared Absorbing Agent>

When an image is formed on the planographic printing plate precursor of the invention with a laser emitting infrared rays of 760 to 1,200 nm as a light source, it is usually necessary to use an infrared absorbing agent. The infrared absorbing agent has a function of converting absorbed infrared rays into heat. By the generated heat, a polymerization initiator (radical generator) described later is thermally decomposed to generate radicals. The infrared absorbing agent used in the invention is preferably a dye or pigment having an absorption peak at a wavelength in the range of 760 to 1,200 nm.

The dye may be selected from commercially available dyes and known dyes described in e.g. “Senryo Binran” (Dye Handbook) (published in 1970 and compiled by Society of Synthetic Organic Chemistry, Japan, the disclosure of which is incorporated by reference herein). Examples of such dyes include azo dyes, metal complex salt azo dyes, pyrazolone azo dyes, naphthoquinone dyes, anthraquinone dyes, phthalocyanine dyes, carbonium dyes, quinone imine dyes, methine dyes, cyanine dyes, squarylium dyes, pyrylium salts and metal thiolate complexes.

Preferable examples of the dyes include cyanine dyes described in JP-A 58-125246, JP-A 59-84356, JP-A 60-78787 etc., methine dyes described in JP-A 58-173696, JP-A 58-181690, JP-A 58-194595 etc., naphthoquinone dyes described in JP-A 58-112793, JP-A 58-224793, JP-A 59-48187, JP-A 59-73996, JP-A 60-52940, JP-A 60-63744 etc., squarylium dyes described in JP-A 58-112792 etc., and cyanine dyes described in UK Patent No. 434,875. The above patent documents are incorporated herein by reference.

Near infrared ray absorbing sensitizers described in U.S. Pat. No. 5,156,938 are also preferable. Also preferably used are substituted aryl benzo(thio) pyrylium salts described in U.S. Pat. No. 3,881,924, trimethine thiapyrylium salts described in JP-A 57-142645 (U.S. Pat. No. 4,327,169), pyrylium compounds described in JP-A 58-181051, JP-A 58-220143, JP-A 59-41363, JP-A 59-84248, JP-A 59-84249, JP-A 59-146063, and JP-A 59-146061, cyanine dye described in JP-A 59-216146, pentamethine thiopyrylium salts described in U.S. Pat. No. 4,283,475, and pyrylium compounds described in JP-B 5-13514 and JP-B 5-19702. Other preferable examples of the dyes include the near infrared ray absorbing dyes of formulae (I) and (II) described in U.S. Pat. No. 4,756,993. The patent documents described above are incorporated by reference herein.

Other preferable examples of the infrared absorbing dye in the invention include specific indolenine cyanine dyes described in JP-A No. 2002-278057 (the disclosure of which is incorporated by reference herein), as shown below.

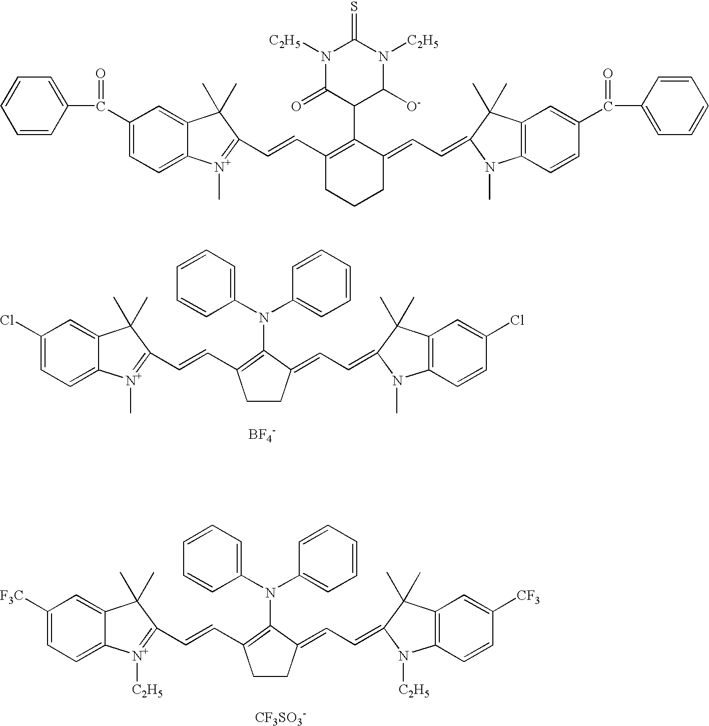

Particularly preferable among these dyes are cyanine dyes, squarylium dyes, pyrylium salts, nickel-thiolate complexes and indolenine cyanine dyes. Cyanine dyes and indolenine cyanine dyes are more preferable, and cyanine dyes represented by the following formula (i) is still more preferable:

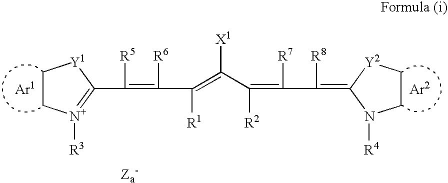

In the formula (i), X¹ represents a hydrogen atom, halogen atom, —NPh₂, X²—L¹ or the group shown below.

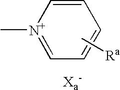

Xa⁻ represents a counter-anion. R^{a} represents a substituent selected from a hydrogen atom, an alkyl group, an aryl group, a substituted or unsubstituted amino group, and a halogen atom.

X² represents an oxygen atom, a nitrogen atom or sulfur atom, and L¹ represents a C₁₋₁₂ hydrocarbon group, an aromatic ring containing a heteroatom, or a C₁₋₁₂ hydrocarbon group containing a heteroatom. The heteroatom refers to N, S, O, halogen atom or Se.

R¹ and R² each independently represent a C₁₋₁₂ hydrocarbon group. From the viewpoint of the storage stability of the recording layer coating liquid, each of R¹ and R² is preferably a hydrocarbon group containing 2 or more carbon atoms. In a preferable embodiment, R¹ and R² are bound to each other to form a 5- or 6-membered ring.

Ar¹ and Ar² may be the same as or different from each other. Ar¹ and Ar¹ each independently represent an aromatic hydrocarbon group which may have a substituent. The aromatic hydrocarbon group is preferably a benzene ring or naphthalene ring. The substituent is preferably a hydrocarbon group containing 12 or less carbon atoms, a halogen atom or an alkoxy group containing 12 or less carbon atoms. Y¹ and Y² may be the same as or different from each other, and each independently represent a sulfur atom or a dialkyl methylene group containing 12 or less carbon atoms. R³ and R⁴ may be the same as or different from each other, and each independently represent a hydrocarbon group containing 20 or less carbon atoms, which may have a substituent. The substituent is preferably an alkoxy group containing 12 or less carbon atoms, a carboxyl group or a sulfo group. R⁵, R⁶, R⁷ and R⁸ may be the same as or different from each other, and each independently represent a hydrogen atom or a hydrocarbon group containing 12 or less carbon atoms. Each of R⁵, R⁶, R⁷ and R⁸ is preferably a hydrogen atom because the starting material is easily available. Za⁻ represents a counter anion. However, when the cyanine dye represented by the formula (a) has an anionic substituent in its structure and thus neutralization of the charge is not necessary, Za⁻ can be omitted. From the viewpoint of the storage stability of the recording layer coating liquid, Za⁻ is preferably a halogen ion, a perchlorate ion, a tetrafluoroborate ion, a hexafluorophosphate ion or a sulfonate ion, particularly preferably a perchlorate ion, a hexafluorophosphate ion or an aryl sulfonate ion.

As examples of the cyanine dyes represented by the formula (i), the cyanine dyes described in columns [0017] to [0019] of JP-A 2001-133969 (the disclosure of which is incorporated by reference herein) may be cited.

Other preferable examples of the infrared absorbing agent in the invention include specific indolenine cyanine dyes described in JP-A No. 2002-278057.

The pigment which can be used in the invention includes commercially available pigments and the pigments described in Color Index (C. I.) Handbook, “Saishin Ganryo Binran” (Newest Dye Handbook) (published in 1977 and compiled by Japanese Society of Pigment Technology), “Saishin Ganryho Oyo Gijyutsu” (Newest Pigment Applied Technology) (published in 1986 by CMC), and “Insatsu Inki Gijyutsu” (Printing Ink Technology) (published in 1984 by CMC). The disclosures of these books are incorporated herein by reference.

Examples of usable pigments include black pigments, yellow pigments, orange pigments, brown pigments, red pigments, violet pigments, blue pigments, green pigments, fluorescent pigments, metallic powder pigments, and other pigments such as polymer-binding dyes. Specific examples thereof include insoluble azo pigments, azo lake pigments, condensed azo pigments, chelate azo pigments, phthalocyanine pigments, anthraquinone pigments, perylene pigments, perinone pigments, thioindigo pigments, quinacridone pigments, dioxazine pigments, isoindolinone pigments, quinophthalone pigments, dyed lake pigments, azine pigments, nitroso pigments, nitro pigments, natural pigments, fluorescent pigments, inorganic pigments, and carbon black. Carbon black is preferable.

The pigments may or may not be subjected to surface treatment before use. The method of surface treatment may be a method of coating the pigment surface with resin or wax, a method of allowing a surfactant to adhere to the pigment surface, or a method of binding a reactive material (e.g., a silane coupling agent, an epoxy compound, a polyisocyanate etc.) onto the pigment surface. These surface treatment methods are described in “Kinzoku Sekken No Seishitsu To Oyo” (Properties and Application of Metallic Soap) (Sachi Shobo), “Insatsu Inki Gijyutsu” (Printing Ink Technology) (published in 1984 by CMC Shuppan) and “Saishin Ganryho Oyo Gijyutsu” (Newest Pigment Applied Technology) (published in 1986 by CMC Shuppan). The disclosures of these books are incorporated herein by reference.

The particle diameter of the pigment is preferably in the range 0.01 to 10 μm, more preferably 0.05 to 1 μm, still more preferably 0.1 to 1 μm. In this range, the excellent dispersion stability of the pigment in the image recording layer coating liquid and the excellent uniformity of the image recording layer can be achieved.

The method of dispersing the pigment may be selected from known dispersion techniques used in production of inks or toners. Examples of the dispersing machine include a supersonic dispersing device, sand mill, attritor, pearl mill, super mill, ball mill, impeller, disperser, KD mill, colloid mill, dynatron, triple roll mill, and press kneader. Details of the dispersing is described in “Saishin Ganryho Oyo Gijyutsu” (Newest Pigment Applied Technology) (published in 1986 by CMC Shuppan).

The infrared absorbing agent may be incorporated into the layer containing other components, or may be incorporated into a separate layer other than the layer containing other components. The infrared absorbing agent is incorporated such that the image recording layer of the resultant negative type planographic printing plate precursor has an absorbance at the absorption peak wavelength within the wavelength range of 760 to 1200 nm is in the range of 0.3 to 1.2, preferably 0.4 to 1.1 when measured by the reflection measurement method. When the absorbance is in the above range, uniform polymerization reaction proceeds in the direction of the depth of the image recording layer, to give excellent film strength of the image region and adhesion to the support.

The absorbance of the image recording layer can be controlled by the amount of the infrared absorbing agent added to the image recording layer and the thickness of the image recording layer. The absorbance can be measured in a usual manner. The measurement method may be, for example: a method comprising forming an image recording layer on a reflective support such as aluminum wherein the thickness of the image recording layer is suitably determined within a thickness range which gives a dry coating amount adequate for a planographic printing plate, then measuring the reflection density of the image recording layer with an optical densitometer; or a method comprising measuring the absorbance with a spectrophotometer by a reflection method using an integrating sphere.

<(B) Polymerization Initiator>

The polymerization initiator (radical generator) used in the invention refers to a compound which generates radicals upon application of light energy and/or heat energy, thus initiates and promotes the polymerization of a compound having a polymerizable unsaturated group. The radical generator used in the invention may be a known heat polymerization initiator, a compound having a bond with a low bond dissociation energy, or a photopolymerization initiator. A preferable example of the radical generator is a compound capable of generating radicals upon application of heat energy, and initiating and promoting the polymerization of a compound having a polymerizable unsaturated group. In the invention, the thermal radical generator may be selected from known polymerization initiators and compounds having a bond with a low bond dissociation energy. Only a single radical generator may be used, or two or more radical generators may be used simultaneously.

Examples of the radical generator include an organic halogenated compound, a carbonyl compound, an organic peroxide compound, an azo polymerization initiator, an azide compound, a metallocene compound, a hexaaryl biimidazole compound, an organic boric acid compound, a disulfonic acid compound, an oxime ester compound and an onium salt compound.

Examples of the organic halogenated compound include compounds described in Wakabayashi et al.: Bull. Chem. Soc. Japan, 42, 2924 (1969), U.S. Pat. No. 3,905,815, JP-B 46-4605, JP-A 48-36281, JP-A 55-32070, JP-A 60-239736, JP-A 61-169835, JP-A 61-169837, JP-A 62-58241, JP-A 62-212401, JP-A 63-70243, JP-A 63-298339, and M. P. Hutt: Journal of Heterocyclic Chemistry, 1 (No. 3), (1970). The disclosures of the above journals and patent documents are incorporated herein by reference. The organic halogenated compound may be an oxazole compound substituted by a trihalomethyl group or an S-triazine compound.

The organic halogenated compound is preferably an s-triazine derivative having at least one mono, di or trihalogen-substituted methyl group on the s-triazine ring. Specific examples thereof include 2,4,6-tris(monochloromethyl)-s-triazine, 2,4,6-tris(dichloromethyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,αβ-trichloroethyl)-4,6-bis(trichloromethyl)-s-triazine, 2-phenyl-4,6-bis(trichloromethyl)-s-triazine, 2-(p-methoxyphenyl)-4,6-bis(trichloromethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl)-4,6-bis(trichloromethyl)-s-triazine, 2-(p-1-propyloxystyryl)-4,6-bis(trichloromethyl)-s-triazine, 2-(p-tolyl)-4,6-bis(trichloromethyl)-s-triazine, 2-(4-naphthoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine, and 2-methoxy-4,6-bis(tribromomethyl)-s-triazine.

Examples of the carbonyl compound include: benzophenone; benzophenone derivatives such as Michler's ketone, 2-methyl benzophenone, 3-methyl benzophenone, 4-methyl benzophenone, 2-chlorobenzophenone, 4-bromobenzophenone, and 2-carboxybenzophenone; acetophenone derivatives such as 2,2-dimethoxy-2-phenyl acetophenone, 2,2-diethoxy acetophenone, 1-hydroxycyclohexylphenyl ketone, α-hydroxy-2-methyl phenyl propanone, 1-hydroxy-1-methylethyl-(p-isopropylphenyl) ketone, 1-hydroxy-1-(p-dodecylphenyl) ketone, 2-methyl-(4′-(methylthio) phenyl)-2-morpholino-1-propanone, and 1,1,1-trichloromethyl-(p-butylphenyl) ketone; thioxanthone; thioxanthone derivatives such as 2-ethyl thioxanthone, 2-isopropyl thioxanthone, 2-chlorothioxanthone, 2,4-dimethyl thioxanthone, 2,4-diethyl thioxanthone, and 2,4-diisopropyl thioxanthone; and benzoate derivatives such as ethyl p-dimethylaminobenzoate and ethyl p-diethylaminobenzoate.

The azo compound may be, for example, selected from the azo compounds described in JP-A 8-108621, the disclosure of which is incorporated by reference herein.

Examples of the organic peroxide compound include trimethyl cyclohexanone peroxide, acetyl acetone peroxide, 1,1-bis(tert-butylperoxy)-3,3,5-trimethyl cyclohexane, 1,1-bis(tert-butylperoxy) cyclohexane, 2,2-bis(tert-butylperoxy) butane, tert-butyl hydroperoxide, cumene hydroperoxide, diisopropyl benzene hydroperoxide, 2,5-dimethylhexane-2,5-dihydroperoxide, 1,1,3,3-tetramethyl butyl hydroperoxide, tert-butyl cumyl peroxide, dicumyl peroxide, 2,5-dimethyl-2,5-di(tert-butylperoxy) hexane, 2,5-oxanoyl peroxide, succinate peroxide, benzoyl peroxide, 2,4-dichlorobenzoyl peroxide, diisopropyl peroxy dicarbonate, di-2-ethylhexyl peroxy dicarbonate, di-2-ethoxyethyl peroxy dicarbonate, dimethoxy isopropyl peroxy carbonate, di(3-methyl-3-methoxybutyl) peroxy dicarbonate, tert-butyl peroxy acetate, tert-butyl peroxy pivalate, tert-butyl peroxy neodecanoate, tert-butyl peroxy octanoate, tert-butyl peroxy laurate, tertiary carbonate, 3,3′,4,4′-tetra-(t-butylperoxycarbonyl) benzophenone, 3,3′,4,4′-tetra-(t-hexylperoxycarbonyl) benzophenone, 3,3′,4,4′-tetra-(p-isopropylcumylperoxycarbonyl) benzophenone, carbonyl di(t-butylperoxy dihydrogen diphthalate), and carbonyl di(t-hexylperoxy dihydrogen diphthalate).

The metallocene compound may be selected from various titanocene compounds described in JP-A 59-152396, JP-A 61-151197, JP-A 63-41484, JP-A 2-249, JP-A 2-4705 and JP-A 5-83588, the disclosures of which are incorporated herein by reference. Specific examples thereof include di-cyclopetadienyl-Ti-bis-phenyl, di-cyclopentadienyl-Ti-bis-2,6-difluorophen-1-yl, di-cyclopentadienyl-Ti-bis-2,4-difluorophen-1-yl, di-cyclopentadienyl-Ti-bis-2,4,6-trifluorophen-1-yl, di-cyclopentadienyl-Ti-bis-2,3,5,6-tetrafluorophen-1-yl, di-cyclopentadienyl-Ti-bis-2,3,4,5,6-pentafluorophen-1-yl, di-methylcyclopentadienyl-Ti-bis-2,6-difluorophen-1-yl, di-methylcyclopentadienyl-Ti-bis-2,4,6-trifluorophen-1-yl, di-methylcyclopentadienyl-Ti-bis-2,3,5,6-tetrafluorophen-1-yl, di-methylcyclopentadienyl-Ti-bis-2,3,4,5,6-pentafluorophen-1-yl, and iron-arene complexes described in JP-A 1-304453 and JP-A 1-152109, the disclosures of which are incorporated by reference herein.

The hexaaryl biimidazole compound may be selected from, for example, various compounds described in JP-B 6-29285, U.S. Pat. Nos. 3,479,185, 4,311,783, and 4,622,286, the disclosures of which are incorporated by reference herein. Specific examples thereof include 2,2′-bis(o-chlorophenyl)-4,4′,5,5′-tetraphenyl biimidazole, 2,2′-bis(o-bromophenyl))-4,4′,5,5′-tetraphenyl biimidazole, 2,2′-bis(o,p-dichlorophenyl)-4,4′,5,5′-tetraphenyl biimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenyl biimidazole, 2,2′-bis(o-nitrophenyl)-4,4′,5,5′-tetraphenyl biimidazole, 2,2′-bis(o-methylphenyl)-4,4′,5,5′-tetraphenyl biimidazole, and 2,2′-bis(o-trifluorophenyl)-4,4′,5,5′-tetraphenyl biimidazole.

Examples of the organic borate compound include: organic borate compounds described in JP-A 62-143044, JP-A 62-150242, JP-A 9-188685, JP-A 9-188686, JP-A 9-188710, JP-A 2000-131837, JP-A 2002-107916, Japanese Patent No. 2764769, JP-A No. 2002-116539, and Kunz, Martin: Rad Tech '98, Proceeding Apr. 19-22, 1998, Chicago; organic boron sulfonium complexes and organic boron oxosulfonium complexes described in JP-A 6-157623, JP-A 6-175564 and JP-A 6-175561; organic boron iodonium complexes described in JP-A 6-175554 and JP-A 6-175553; organic boron phosphonium complexes described in JP-A 9-188710; and organic boron transition metal coordination complexes described in JP-A 6-348011, JP-A 7-128785, JP-A 7-140589, JP-A 7-306527 and JP-A 7-292014. The disclosures of the above patent documents are incorporated herein by reference.

The disulfone compound may be selected from the compounds described in JP-A 61-166544 and JP-A No. 2002-328465, the disclosures of which are incorporated herein by reference.

The oxime ester compound may be selected from the compounds described in J. C. S. Perkin II (1979) 1653-1660), J. C. S. Perkin II (1979) 156-162, Journal of Photopolymer Science and Technology (1995) 202-232 and JP-A 2000-66385 and JP-A 2000-80068, the disclosures of which are incorporated by reference herein. Specific examples of the oxime ester compound are shown below.

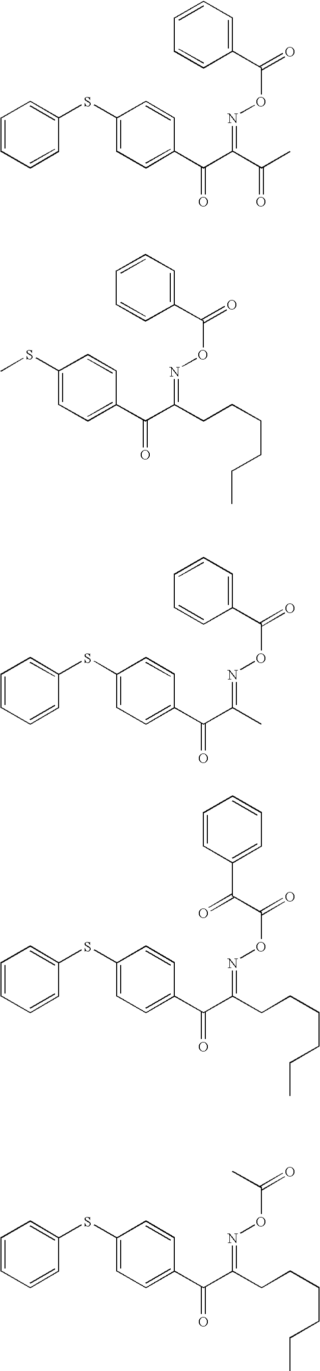

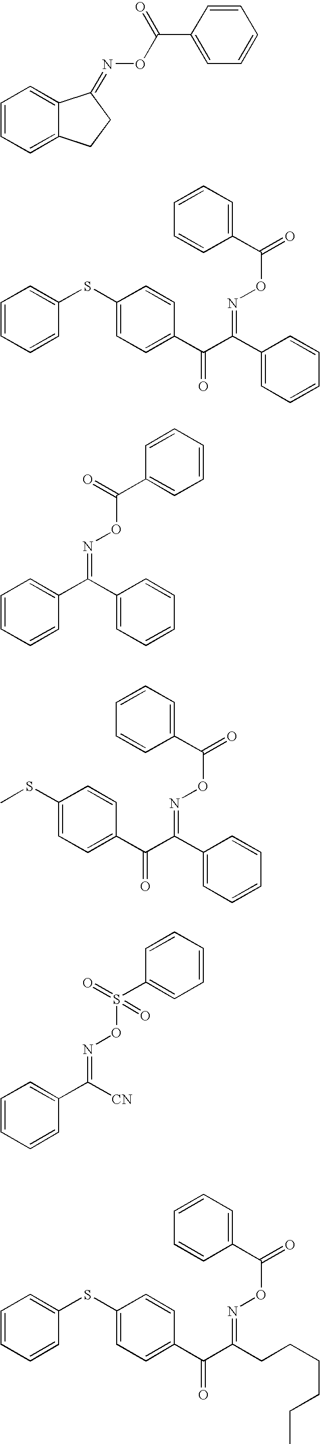

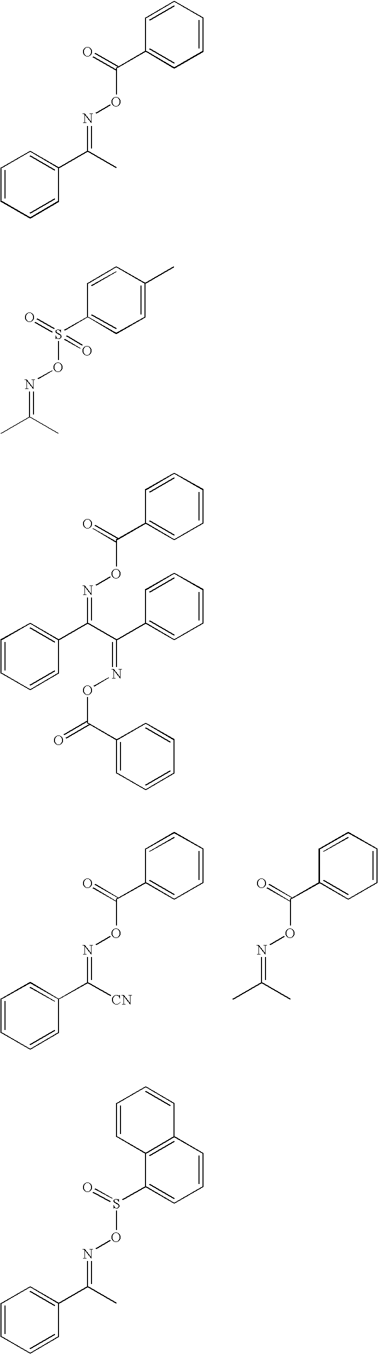

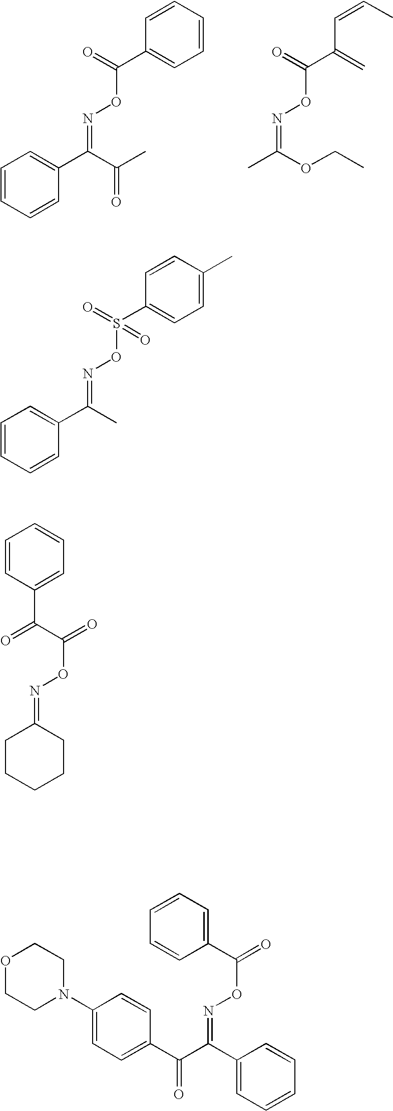

Examples of the onium salt compound include: diazonium salts described in S. I. Schlesinger, Photogr. Sci. Eng., 18, 387 (1974) and T. S. Bal et al., Polymer, 21, 423 (1980); ammonium salts described in U.S. Pat. No. 4,069,055 and JP-A 4-365049, phosphonium salts described in U.S. Pat. Nos. 4,069,055 and 4,069,056; iodonium salts described in European Patent No. 104,143, U.S. Pat. Nos. 339,049 and 410,201, JP-A 2-150848 and JP-A 2-296514; sulfonium salts described in European Patent Nos. 370,693, 390, 214, 233, 567, 297,443 and 297,442, U.S. Pat. Nos. 4,933,377, 161, 811, 410, 201, 339,049, 4,760,013, 4,734,444 and 2,833,827, and German Patent Nos. 2,904,626, 3,604,580 and 3,604,581; selenonium salts described in J. V. Crivello et al., Macromolecules, 10(6), 1307 (1977) and J. V. Crivello et al., J. Polymer Sci., Polymer Chem. Ed., 17, 1047 (1979); and onium salts such as arsonium salts described in C. S. Wen et al., Teh, Proc. Conf. Rad. Curing ASIA, p. 478, Tokyo, Oct. (1988). The oxime ester compounds, diazonium salts, iodonium salts, and sulfonium salts are preferred from the viewpoint of reactivity and stability. In the invention, these onium salts function not as acid generators but as ionic radical polymerization initiators.

In the invention, the onium salts represented by the following formulae (RI-I) to (RI-III) are preferable.
Ar¹¹—I⁺—Ar¹² Z¹¹⁻ Formula (RI-I)
Ar²¹—N≡N Z²¹⁻ Formula (RI-III)

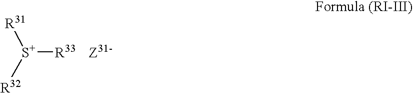

In the formula (RI-I), Ar¹¹ and Ar¹² each independently represent an aryl group containing 20 or less carbon atoms, which may have 1 to 6 substituents, and the substituents are preferably selected from alkyl groups each containing 1 to 12 carbon atoms, alkenyl groups each containing 1 to 12 carbon atoms, alkynyl groups each containing 1 to 12 carbon atoms, aryl groups each containing 1 to 12 carbon atoms, alkoxy groups each containing 1 to 12 carbon atoms, aryloxy groups each containing 1 to 12 carbon atoms, halogen atoms, alkylamino groups each containing 1 to 12 carbon atoms, dialkylamino groups each containing 1 to 12 carbon atoms, alkyl amide groups each containing 1 to 12 carbon atoms, aryl amide groups each containing 1 to 12 carbon atoms, carbonyl groups, carboxyl groups, cyano groups, sulfonyl groups, thioalkyl groups each containing 1 to 12 carbon atoms, and thioaryl groups each containing 1 to 12 carbon atoms. Z¹¹⁻ represents a monovalent anion which may be selected from a halogen ion, a perchlorate ion, a hexafluorophosphate ion, a tetrafluoroborate ion, a sulfonate ion, a sulfinate ion, a thiosulfonate ion and a sulfate ion. Z¹¹⁻ preferably represents a perchlorate ion, a hexafluorophosphate ion, a tetrafluoroborate ion, a sulfonate ion, or a sulfinate ion from the viewpoint of stability.

In the formula (RI-II), Ar²¹ represents an aryl group containing 20 or less carbon atoms, which may have 1 to 6 substituents, and the substituents are preferably selected from alkyl groups each containing 1 to 12 carbon atoms, alkenyl groups each containing 1 to 12 carbon atoms, alkynyl groups each containing 1 to 12 carbon atoms, aryl groups each containing 1 to 12 carbon atoms, alkoxy groups each containing 1 to 12 carbon atoms, aryloxy groups each containing 1 to 12 carbon atoms, halogen atoms, alkylamino groups each containing 1 to 12 carbon atoms, dialkylamino groups each containing 1 to 12 carbon atoms, alkyl amide groups each containing 1 to 12 carbon atoms, aryl amide groups each containing 1 to 12 carbon atoms, carbonyl groups, carboxyl groups, cyano groups, sulfonyl groups, thioalkyl groups each containing 1 to 12 carbon atoms, and thioaryl groups each containing 1 to 12 carbon atoms. Z²¹⁻represents a monovalent anion which may be selected from a halogen ion, a perchlorate ion, a hexafluorophosphate ion, a tetrafluoroborate ion, a sulfonate ion, a sulfinate ion, a thiosulfonate ion and a sulfate ion. Z²¹⁻ preferably represents a perchlorate ion, a hexafluorophosphate ion, a tetrafluoroborate ion, a sulfonate ion, a sulfinate ion, or a carboxylate ion from the viewpoint of stability and reactivity.

In the formula (RI-III), R³¹, R³² and R³³ each independently represent an aryl group, alkyl group, alkenyl group or alkynyl group containing 20 or less carbon atoms which may have 1 to 6 substituents, and is preferably an aryl group in respect of reactivity and safety. The substituents are preferably selected from alkyl groups each containing 1 to 12 carbon atoms, alkenyl groups each containing 1 to 12 carbon atoms, alkynyl groups each containing 1 to 12 carbon atoms, aryl groups each containing 1 to 12 carbon atoms, alkoxy groups each containing 1 to 12 carbon atoms, aryloxy groups each containing 1 to 12 carbon atoms, halogen atoms, alkylamino groups each containing 1 to 12 carbon atoms, dialkylamino groups each containing 1 to 12 carbon atoms, alkyl amide groups each containing 1 to 12 carbon atoms, aryl amide groups each containing 1 to 12 carbon atoms, carbonyl groups, carboxyl groups, cyano groups, sulfonyl groups, thioalkyl groups each containing 1 to 12 carbon atoms, and thioaryl groups each containing 1 to 12 carbon atoms. Z³¹⁻ represents a monovalent anion which may be selected from a halogen ion, a perchlorate ion, a hexafluorophosphate ion, a tetrafluoroborate ion, a sulfonate ion, a sulfinate ion, a thiosulfonate ion and a sulfate ion. Z³¹⁻ preferably represents a perchlorate ion, a hexafluorophosphate ion, a tetrafluoroborate ion, a sulfonate ion, a sulfinate ion, or a carboxylate ion from the viewpoint of stability and reactivity. In an embodiment, Z³¹⁻ represents a carboxylate ion disclosed in JP-A 2001-343742, the disclosure of which is incorporated by reference herein. In another embodiment, Z³¹⁻ represents a carboxylate ion disclosed in JP-A 2002-148790, the disclosure of which is incorporated by reference herein.

Examples of the polymerization initiator usable in the invention are shown below. However, the examples should not be construed as limiting the invention.

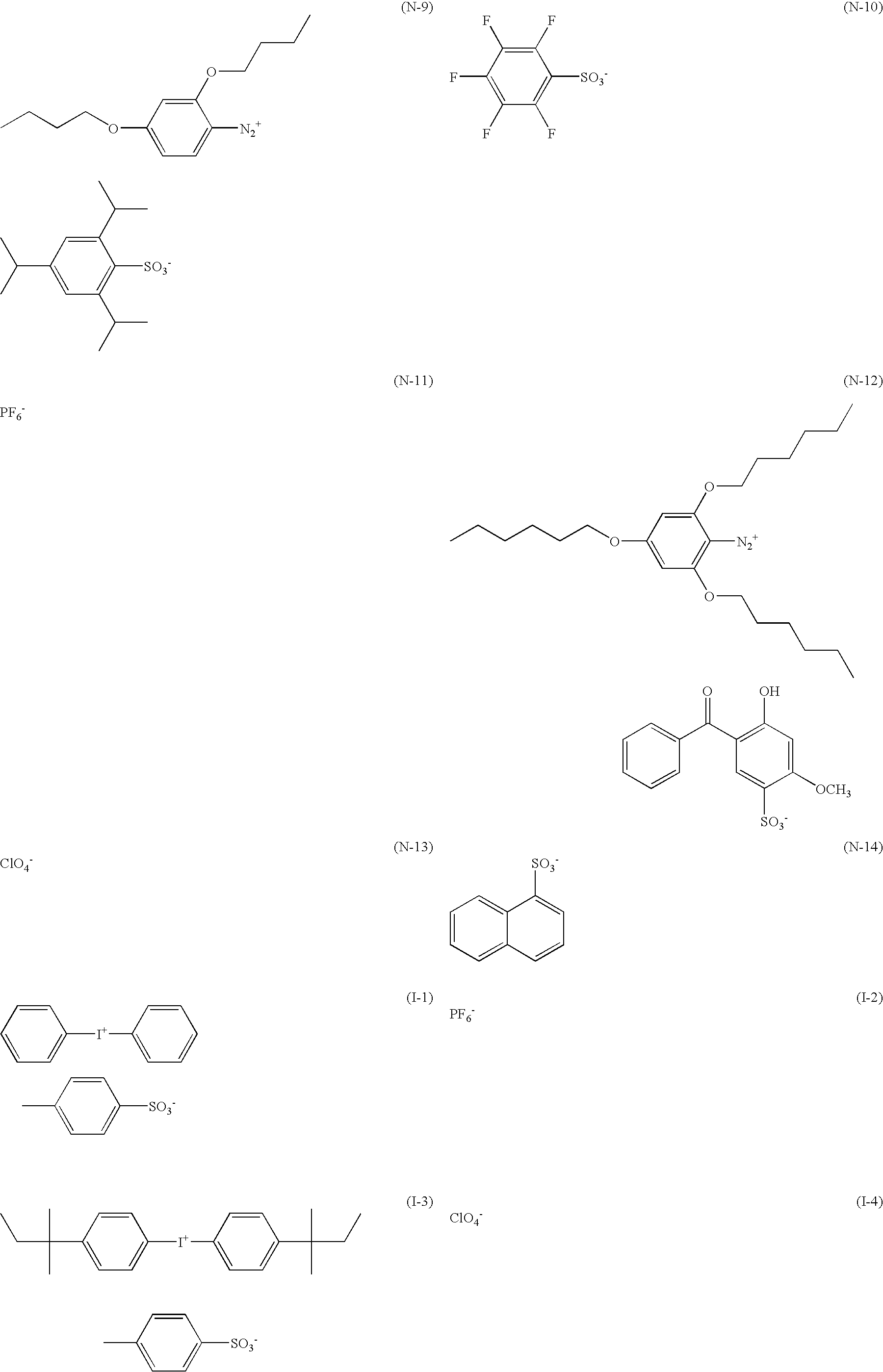

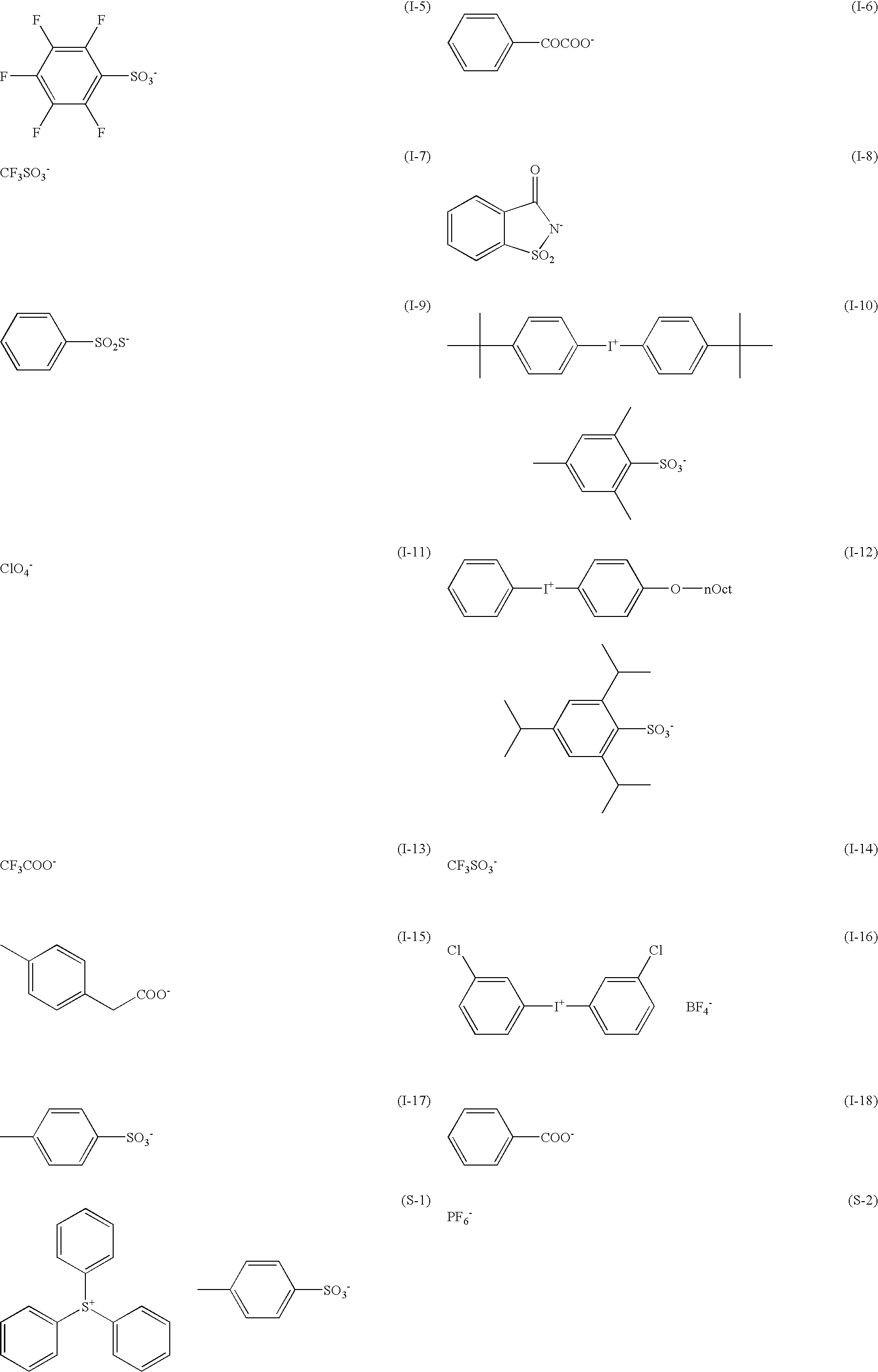

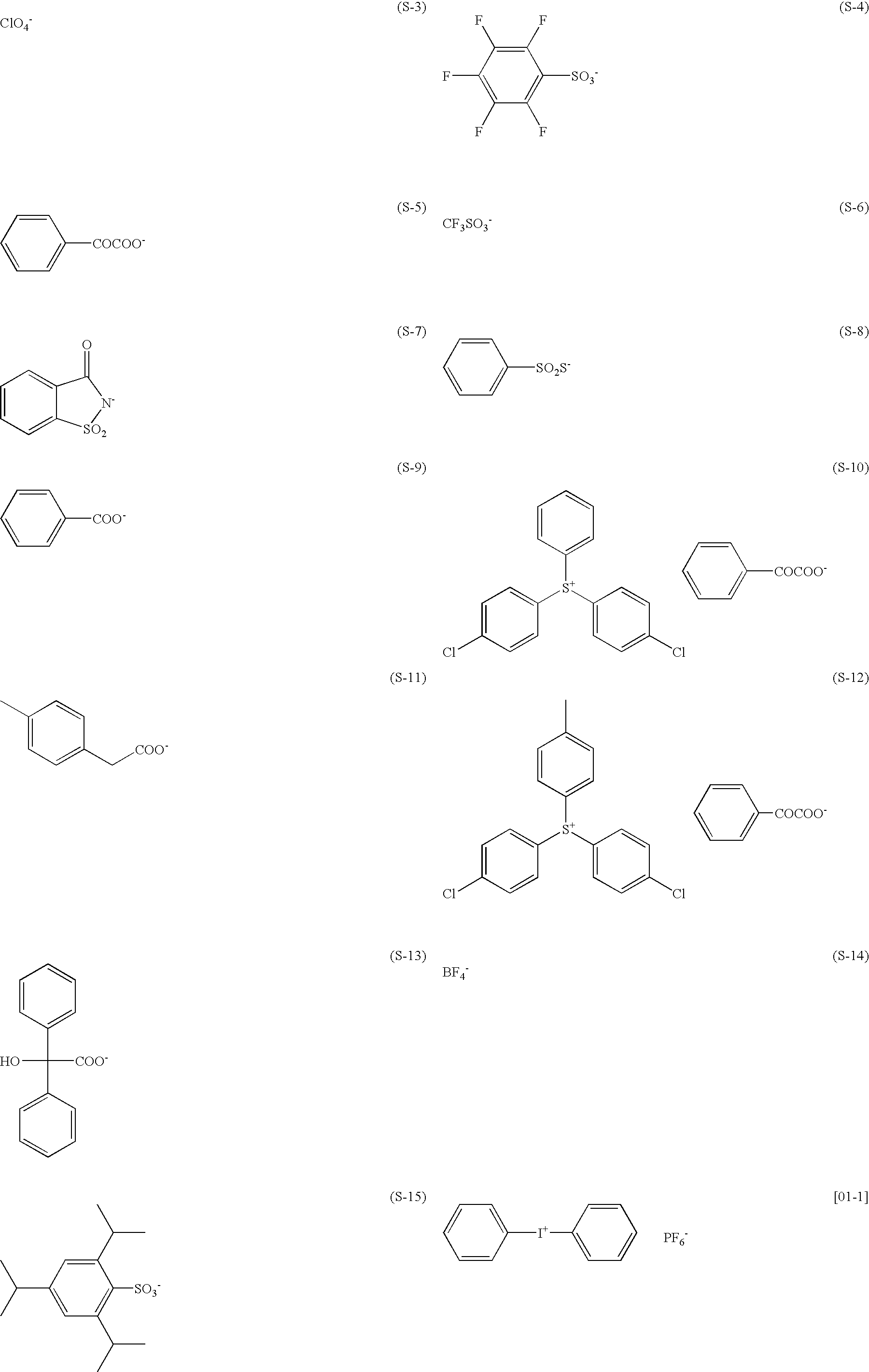

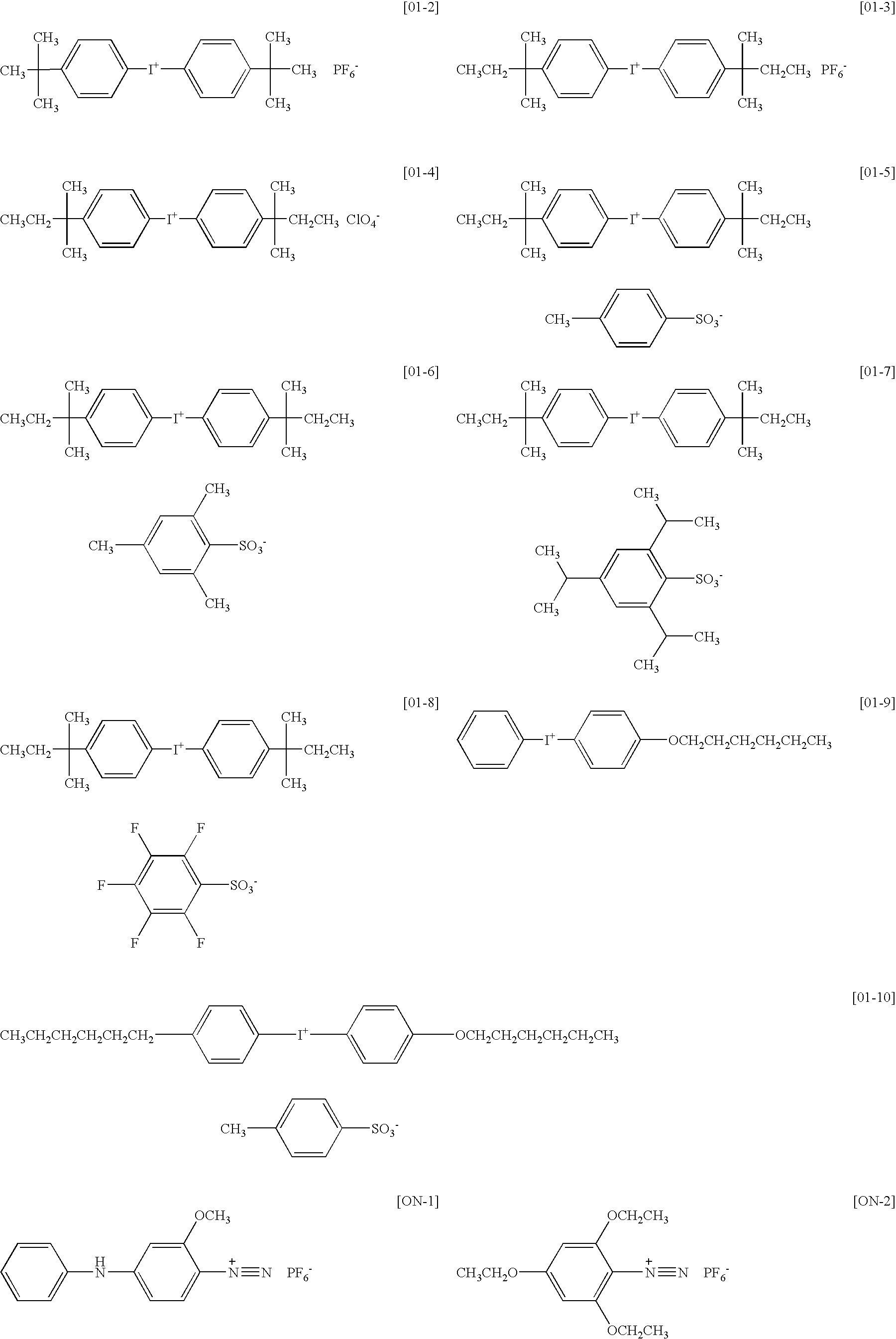

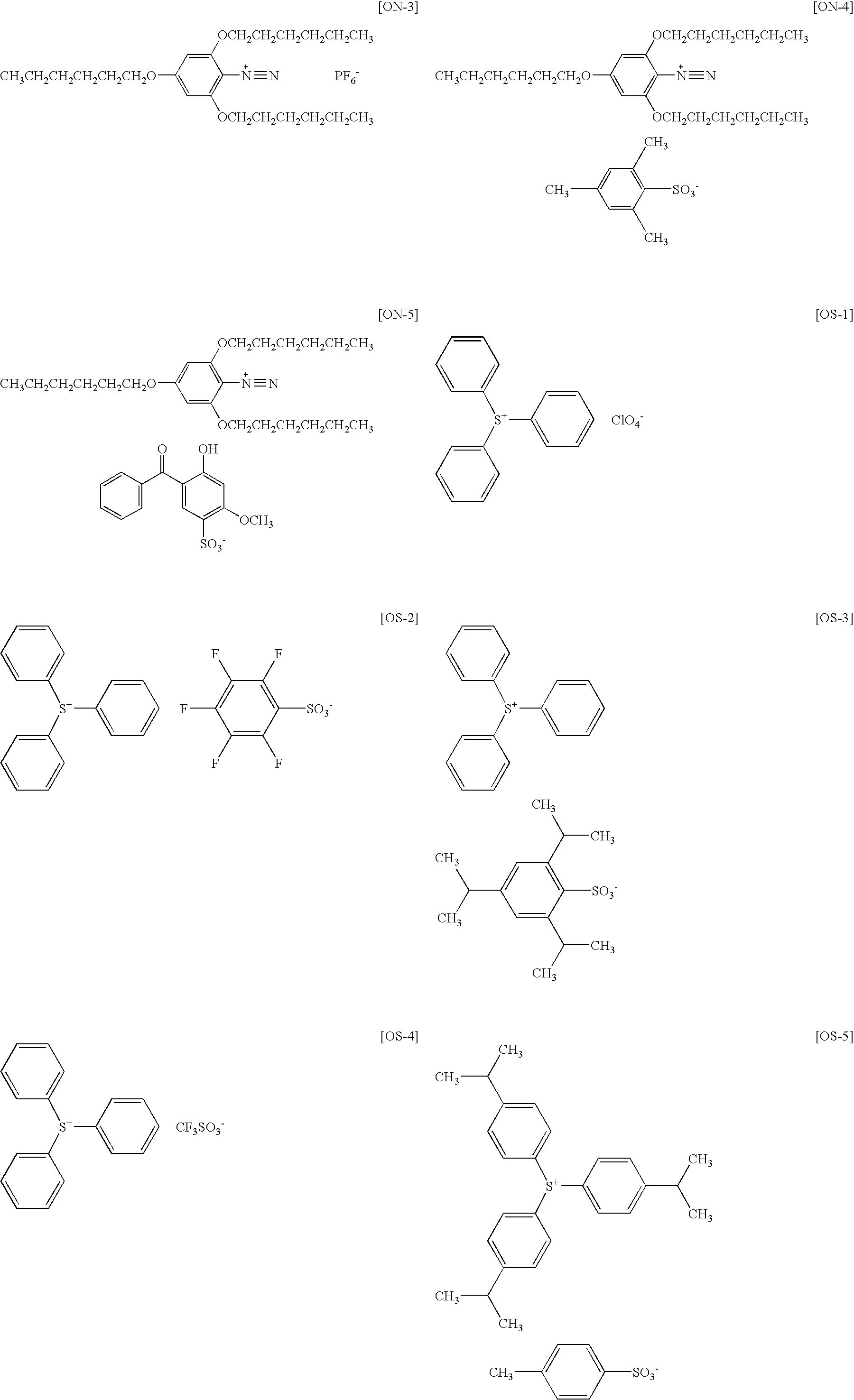

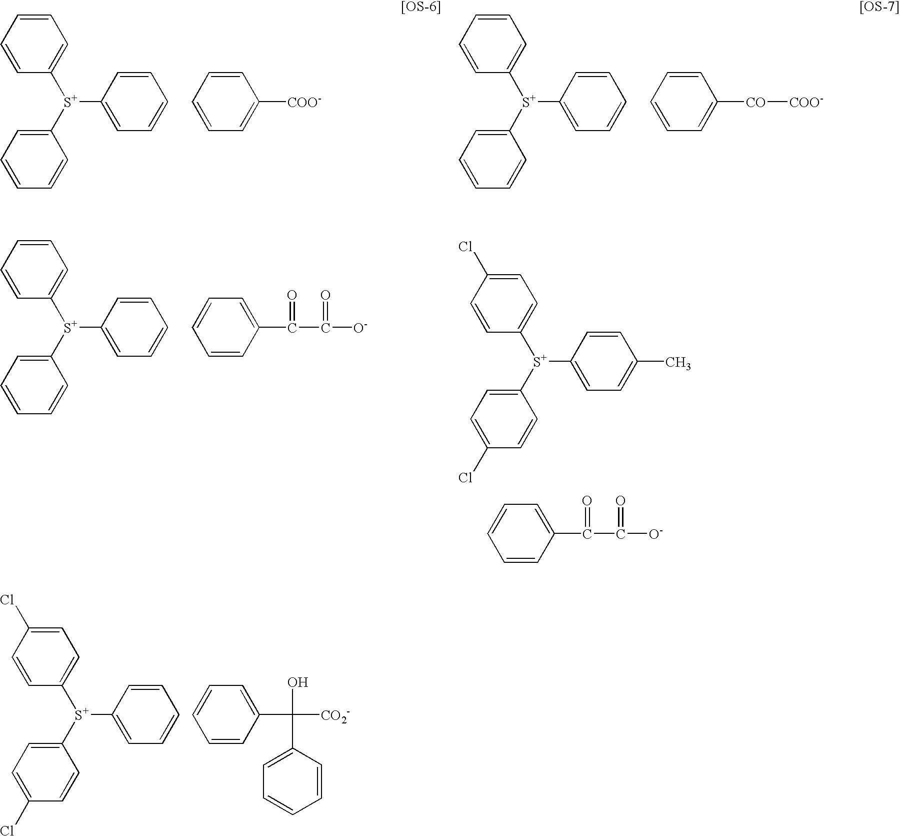

The content of the polymerization initiator in the total solid constituting the image recording layer may be 0.1 to 50% by weight, preferably 0.5 to 30% by weight, more preferably 1 to 20% by weight. When the content is within the above range, high sensitivity and excellent stain resistance of a non-image region during printing can be achieved. Only a single polymerization initiator may be used or two or more polymerization initiators may be used in combination. The polymerization initiator may be incorporated into the layer containing other components or may be incorporated into a separate layer different from the layer containing other components.

<(C) Polymerizable Compound>

The polymerizable compound which can be used in the invention is an addition-polymerizable compound having at least one ethylenically unsaturated double bond, and is selected from compounds each having at least one (preferably two or more) terminal ethylenic unsaturated bond. Such compounds are known widely in the related industrial field, and in the invention, the polymerizable compound is selected from these compounds without any particular limitation. The polymerizable compound may be in the chemical form of a monomer, a prepolymer (a dimer, a trimer, an oligomer, or the like), a mixture thereof, or a copolymer thereof. Examples of the monomer and copolymer include unsaturated carboxylic acids (e.g., acrylic acid, methacrylic acid, itaconic acid, crotonic acid, isocrotonic acid, and maleic acid), esters thereof, and amides thereof. The polymerizable monomer is preferably: an ester between an unsaturated carboxylic acid and an aliphatic polyvalent alcohol; an amide between an unsaturated carboxylic acid and an aliphatic polyvalent amine; an addition-reaction product of an unsaturated carboxylic ester or amide having a nucleophilic substituent such as a hydroxyl group, an amino group, or a mercapto group, with a monofunctional or multifunctional isocyanate or an epoxy compound; a dehydration condensation reaction product of an unsaturated carboxylic ester or amide having a nucleophilic substituent such as a hydroxyl group, an amino group, or a mercapto group, with a monofunctional or multifunctional carboxylic acid; an addition-reaction product of an unsaturated carboxylic ester or amide having an electrophilic substituent such as an isocyanate group or an epoxy group, with a monofunctional or multifunctional alcohol, amine or thiol; or a substitution-reaction product of an unsaturated carboxylic ester or amide having an dissociative substituent such as a halogen group or a tosyloxy group, with a monofunctional or multifunctional alcohol, amines or thiol. In the above examples, the unsaturated carboxylic acid may replaced by an unsaturated phosphonic acid, styrene, a vinyl ether, or the like.

The ester (monomer) between an aliphatic polyvalent alcohol and an unsaturated carboxylic acid may be an acrylic ester. Examples such an acrylic ester include ethylene glycol diacrylate, triethylene glycol diacrylate, 1,3-butane diol diacrylate, tetramethylene glycol diacrylate, propylene glycol diacrylate, neopentyl glycol diacrylate, trimethylol propane triacrylate, trimethylol propane tri(acryloyloxypropyl)ether, trimethylol ethane triacrylate, hexane diol diacrylate, 1,4-cyclohexane diol diacrylate, tetraethylene glycol diacrylate, pentaerythritol diacrylate, pentaerythritol triacrylate, pentaerythritol tetracrylate, dipentaerythritol diacrylate, dipentaerythritol hexacrylate, sorbitol triacrylate, sorbitol tetracrylate, sorbitol pentacrylate, sorbitol hexacrylate, tri(acryloyloxyethyl) isocyanurate, polyester acrylate oligomers, and isocyanuric acid EO-modified triacrylate.

The ester (monomer) between an aliphatic polyvalent alcohol and an unsaturated carboxylic acid may be a methacrylic ester. Examples such a methacrylic ester include tetramethylene glycol dimethacrylate, triethylene glycol dimethacrylate, neopentyl glycol dimethacrylate, trimethylol propane trimethacrylate, trimethylol ethane trimethacrylate, ethylene glycol dimethacrylate, 1,3-butane diol dimethacrylate, hexane diol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethyl methane, and bis[p-(methacryloxyethoxy)phenyl]dimethyl methane.

The ester (monomer) between an aliphatic polyvalent alcohol and an unsaturated carboxylic acid may be an itaconic ester. Examples such an itaconic ester include ethylene glycol diitaconate, propylene glycol diitaconate, 1,3-butane diol diitaconate, 1,4-butane diol diitaconate, tetramethylene glycol diitaconate, pentaerythritol diitaconate, and sorbitol tetraitaconate. The ester (monomer) between an aliphatic polyvalent alcohol and an unsaturated carboxylic acid may be a crotonic ester. Examples such a crotonic ester include ethylene glycol dicrotonate, tetramethylene glycol dicrotonate, pentaerythritol dicrotonate, and sorbitol tetradicrotonate.

The ester (monomer) between an aliphatic polyvalent alcohol and an unsaturated carboxylic acid may be an isocrotonic ester. Examples such an isocrotonic ester include ethylene glycol diisocrotonate, pentaerythritol diisocrotonate, and sorbitol tetraisocrotonate. The ester (monomer) between an aliphatic polyvalent alcohol and an unsaturated carboxylic acid may be a maleic ester. Examples such a maleic ester include ethylene glycol dimaleate, triethylene glycol dimaleate, pentaerythritol dimaleate, and sorbitol tetramaleate.

The polymerizable compound may be an ester other than the esters described above. Examples of such an ester include aliphatic alcohol-based esters described in JP-B 51-47334 and JP-A 57-196231, esters each having an aromatic skeleton described in JP-A 59-5240, JP-A 59-5241 and JP-A 2-226149, and esters each having an amino group described in JP-A 1-165613. The disclosures of the above patent documents are incorporated herein by reference. It is also possible to use a mixture of ester monomers selected from the ester monomers described above.

Examples of the amide (monomer) between an aliphatic polyvalent amine and an unsaturated carboxylic acid include methylene bis-acrylamide, methylene bis-methacrylamide, 1,6-hexamethylene bis-acrylamide, 1,6-hexamethylene bis-methacrylamide, diethylene triamine trisacrylamide, xylylene bisacrylamide, and xylylene bismethacrylamide. Preferable examples of other amide type monomers include the amid type monomers each having a cyclohexylene structure described in JP-B 54-21726, the disclosure of which is incorporated by reference herein.

The polymerizable compound may be an urethane addition-polymerizable compound produced by addition reaction between an isocyanate and a hydroxyl group. The urethane addition-polymerizable compound may be a vinyl urethane compound having two or more polymerizable vinyl groups disclosed in JP-B 48-41708, the disclosure of which is incorporated by reference herein. The vinyl urethane compound can be prepared by allowing a vinyl monomer having a hydroxyl group represented by the following formula (II) and a polyisocyanate having two or more isocyanate groups to undergo an addition reaction.
CH₂═C(R₄)COOCH₂CH(R₅)OH (II)
wherein R₄ and R₅ each independently represent H or CH₃.

The polymerizable compound may be selected from the urethane acrylates described in JP-A 51-37193, JP-B 2-32293 and JP-B 2-16765 and the urethane compounds having ethylene oxide type skeletons described in JP-B 58-49860, JP-B 56-17654, JP-B 62-39417 and JP-B 62-39418. Addition-polymerizable compounds each containing an amino structure or sulfide structure described in JP-A 63-277653, JP-A 63-260909 and JP-A 1-105238 can be used to prepare photopolymerizable compositions extremely excellent in photosupersensitization speed. The disclosures of the above patent documents are incorporated herein by reference.

Examples of the polymerizable compound further include: multifunctional acrylates and methacrylates such as polyester acrylates disclosed in JP-A 48-64183, JP-B 49-43191 and JP-B 52-30490 and epoxy acrylates obtained by allowing epoxy resins to react with (meth)acrylic acid; specific unsaturated compounds disclosed in JP-B 46-43946, JP-B 1-40337 and JP-B 1-40336; vinyl phosphonic acid compounds disclosed in JP-A 2-25493; a structure containing a perfluoroalkyl group disclosed in JP-A 61-22048; and photosetting monomers and oligomers disclosed in the Journal of Japanese Adhesive Society, vol. 20, No. 7, pp. 300-308 (1984). The disclosures of the above patent documents and journal are incorporated herein by referenc.

Details (such as the structure, amount, and whether used alone or in combination with another addition-polymerizable compounds) of the method for using the addition-polymerizable compound may be arbitrary determined in accordance with the design of the performance of the resultant planographic printing plate precursor. For example, the addition polymerizable compound can be selected from the following viewpoints. In respect of the sensitivity, the addition-polymerizable compound preferably has a structure containing many unsaturated groups in one molecule; in many cases, the addition-polymerizable compound preferably has bi-or higher-functionality. To increase the strength of the image region (cured layer), the addition-polymerizable compound preferably has tri- or higher-functionality. It is also effective to control both the sensitivity and the strength by using a combination of addition-polymerizable compounds (e.g. acrylates, methacrylates, styrene compounds, and vinyl ether compounds) having different functionalities and different polymerizable groups.

The selection and manner of use of the addition-polymerizable compound is an important factor for compatibility with other components (e.g. a binder polymer, an initiator, and a colorant) in the image recording layer and dispersibility in the image recording layer. The compatibility may be improved by using e.g. an addition-polymerizable compound with low purity or a combination of two or more addition-polymerizable compounds. A specific structure can be selected for the purpose of improving the adhesion of the image recording layer to a support, an overcoat layer described later, etc.

The addition-polymerizable compound is used preferably in the range of 5 to 80% by weight, more preferably 25 to 75% by weight, based on the weight of the nonvolatile components in the image recording layer. Only a single addition-polymerizable compound may be used, or two or more addition-polymerizable compounds may be used. When the addition-polymerizable compound is used, the structure, amount, addition manner of the addition-polymerizable compound may be selected arbitrary, considering the degree of polymerization inhibition caused by oxygen, the resolution, the fogging property, the change in reflectance, and the surface adhesiveness of the image recording layer. An undercoat layer may be provided under the image recording layer and an overcoat layer may be provided on the image recording layer.

<(D) Binder Polymer>

In the invention, the binder polymer may be selected from conventionally known binder polymers without limitation. The binder polymer is preferably a film-forming polymer. Examples of the binder polymer include acrylic resin, polyvinyl acetal resin, polyurethane resin, polyurea resin, polyimide resin, polyamide resin, epoxy resin, methacrylic resin, polystyrene resin, novolak phenol resin, polyester resin, synthetic rubber and natural rubber.

To improve the strength of a film in an image region, the binder polymer preferably has crosslinkability. To allow the binder polymer to have crosslinkability, crosslinkable functional groups such as ethylenically unsaturated bonds may be introduced into the main chain or a side chain of the polymer. The crosslinkable functional groups may be introduced by copolymerization.

The polymer having an ethylenically unsaturated bond in the main chain may be, for example, poly-1,4-butadiene or poly-1,4-isoprene.

The polymer having an ethylenically unsaturated bond in a side chain thereof may be, for example, a polymer of an ester or amide of acrylic acid or methacrylic acid wherein the ester or amide residue (R in —COOR or —CONHR) has an ethylenically unsaturated bond.

Examples of the residue (the above-mentioned R) having an ethylenically unsaturated bond includes —CH₂)ₙCR¹═CR²R³, —(CH₂O)ₙCH₂CR¹═CR²R³, —(CH₂CH₂O)ₙCH₂CR¹═CR²R³, —(CH₂)ₙNH—CO—O—CH₂CR¹═CR²R³, —(CH₂)ₙ—O—CO—CR¹═CR²R³ and —(CH₂CH₂O)₂—X wherein R¹ to R³ each independently represent a hydrogen atom, a halogen atom or a C1 to C20 alkyl, aryl, alkoxy or aryloxy group; R¹ and R² or R¹ and R³ may be bound to each other to form a ring; n is an integer of 1 to 10; and X represents a dicyclopentadienyl residue.

Examples of the ester residue include —CH₂CH═CH₂ (described in JP-B 7-21633), —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂, and —CH₂CH₂O—X wherein X represents a dicyclopentadienyl residue.

Examples of the amide residue include —CH₂CH═CH₂, —CH₂CH₂—Y (Y is a cyclohexene residue) and —CH₂CH₂—OCO—CH═CH₂.

The crosslinkable binder polymer is cured, for example, through the following mechanism: a free radical (a polymerization initiation radical or a growing radical of a polymerizable compound in the process of polymerization) combines to the crosslinkable functional group of the crosslinkable binder polymer, whereby the crosslinkable binder polymer chains are combined directly or via the growing chain of the polymerizable compound, to form crosslinkages between the polymer molecules. In another example of the mechanism, an atom (for example, a hydrogen atom bound to a carbon atom adjacent to the functional crosslinkable group) in the polymer is withdrawn by a free radical to generate a polymer radical, then the polymer radical combines with another polymer radical to form crosslinkages between the polymer molecules, whereby the binder polymer is cured.

The content of the crosslinkable group in the binder polymer (content of radical-polymerizable unsaturated double bonds determined by iodine titration) is preferably 0.1 to 10.0 mmol, more preferably 1.0 to 7.0 mmol, and most preferably 2.0 to 5.5 mmol, per g of the binder polymer. When the content is in this range, good sensitivity and good storage stability can be obtained.

From the viewpoint of improving the on-press developability of an unexposed region in the image recording layer, the binder polymer is preferably a compound having high solubility or dispersibility in ink and/or moistening water.

For improving solubility or dispersibility in ink, the binder polymer is preferably lipophilic, and for improving solubility or dispersibility in moistening water, the binder polymer is preferably hydrophilic. Accordingly, simultaneous use of a lipophilic binder polymer and a hydrophilic binder polymer is also effective in the invention.

The hydrophilic binder is preferably a binder having a hydrophilic group. Examples thereof include a hydroxyl group, carboxyl group, carboxylate group, hydroxyethyl group, polyoxyethyl group, hydroxypropyl group, polyoxypropyl group, amino group, aminoethyl group, aminopropyl group, ammonium group, amide group, carboxymethyl group, sulfonic acid group and phosphoric acid group.

Specific examples of the hydrophilic binder polymer include gum arabic, casein, gelatin, starch derivatives, carboxymethyl cellulose and sodium salts thereof, cellulose acetate, sodium alginate, vinyl acetate-maleic acid copolymers, styrene-maleic acid copolymers, polyacrylic acids and salts thereof, polymethacrylic acids and salts thereof, hydroxyethyl methacrylate homopolymers and copolymers, hydroxyethyl acrylate homopolymers and copolymers, hydroxypropyl methacrylate homopolymers and copolymers, hydroxypropyl acrylate homopolymers and copolymers, hydroxybutyl methacrylate homopolymers and copolymers, hydroxybutyl acrylate homopolymers and copolymers, polyethylene glycols, hydroxypropylene polymers, polyvinyl alcohols, hydrolyzed polyvinyl acetate with hydrolyzation degree of at least 60% by weight, preferably at least 80% by weight, polyvinyl formal, polyvinyl butyral, polyvinyl pyrrolidone, acrylamide homopolymers and copolymers, methacrylamide homopolymers and copolymers, N-methylol acrylamide homopolymers and copolymers, polyvinyl pyrrolidone, alcohol-soluble nylon, and polyether formed by 2,2-bis-(4-hydroxyphenyl)-propane and epichlorohydrin.

The weight-average molecular weight of the binder polymer (D) is preferably 5,000 or larger, more preferably in the range of 10,000 to 300,000, and the number-average molecular weight thereof is preferably 1,000 or larger, more preferably in the range of 2,000 to 250,000. Polydispersity (weight-average molecular weight/number-average molecular weight) is preferably in the range of 1.1 to 10.

The binder polymer (D) can be synthesized in a method known in the art. Examples of the solvent used in the synthesis include tetrahydrofuran, ethylene dichloride, cyclohexanone, methyl ethyl ketone, acetone, methanol, ethanol, ethylene glycol monomethyl ether, ethylene glycol monoethyl ether, 2-methoxyethyl acetate, diethylene glycol dimethyl ether, 1-methoxy-2-propanol, 1-methoxy-2-propyl acetate, N,N-dimethyl formamide, N,N-dimethyl acetamide, toluene, ethyl acetate, methyl lactate, ethyl lactate, dimethyl sulfoxide, and water. Only a single solvent may be used or a mixture of two or more solvents may be used.

The radical polymerization initiator used for synthesizing the binder polymer (D) may be a known compound such as an azo-type initiator or a peroxide initiator.

The content of the binder polymer (D) is 5 to 90 wt %, preferably 5 to 80 wt %, more preferably 10 to 70 wt %, relative to the total solids content of the image recording layer. When the content is in this range, excellent strength of an image region and image formability can be obtained.

The polymerizable compound (C) and the binder polymer (D) are used preferably in a ratio (polymerizable compound (C)/the binder polymer (D)) of from 0.5/1 to 4/1 by weight.

In the invention, the image recording layer may include the components (A) to (D) and other optional components described later in any of the following forms. In an embodiment, the image recording layer is a molecular dispersion type image recording layer obtained by applying a coating liquid in which the components are dissolved in a suitable solvent, as described in JP-A 2002-287334, the disclosure of which is incorporated by reference herein. In another embodiment, the image recording layer is a microcapsule-type image recording layer including microcapsules which contain some of or all of the components, as described in JP-A 2001-277740 and JP-A 2001-277742, the disclosures of which are incorporated herein by reference. In the microcapsule-type image recording layer, the components may also be contained in the space in the image recording layer, the space being out of the microcapsules. In a preferable embodiment, in the microcapsule-type image recording layer, the hydrophobic components are contained in the microcapsules, while the hydrophilic components are contained in the space out of the microcapsules. For attaining higher on-press developability, the image recording layer is preferably a microcapsule-type image recording layer.

A known method may be employed for encapsulating the image recording layer components (A) to (D). Examples of the encapsulation method include, but is not limited to: a method of utilizing coacervation disclosed in U.S. Pat. Nos. 2,800,457 and 2,800,458; a method of interfacial polymerization disclosed in U.S. Pat. No. 3,287,154, JP-B 38-19574 and JP-B 42-446; a method of precipitating polymers disclosed in U.S. Pat. Nos. 3,418,250 and 3,660,304, a method of using an isocyanate polyol wall material disclosed in U.S. Pat. No. 3,796,669, a method of using an isocyanate wall material disclosed in U.S. Pat. No. 3,914,511, a method of using an urea-formaldehyde type or urea-formaldehyde-resorcinol type wall-forming material disclosed in U.S. Pat. Nos. 4,001,140, 4,087,376 and 4089802, a method of using a wall material such as melamine-formaldehyde resin and hydroxy cellulose disclosed in U.S. Pat. No. 4,025,445, a method of in situ polymerization of monomers disclosed in JP-B 36-9163 and JP-B 51-9079, a method of spray drying disclosed in GB Patent No. 930422 and U.S. Pat. No. 3,111,407, and a method of electrolytic dispersion cooling disclosed in GB Patent Nos. 952807 and 967074.

The microcapsule wall used in the invention preferably has 3-dimensional crosslinkages, and is preferably swellable with a solvent. From such a viewpoint, the wall material for the microcapsules is preferably selected from polyurea, polyurethane, polyester, polycarbonate, polyamide and a mixture thereof. Polyurea and polyurethane are particularly preferable. A compound having a crosslinkable functional group such as an ethylenically unsaturated bond may be introduced into the microcapsule wall. The compound having a crosslinkable functional group may be selected from the compounds described above as the compounds which can be used in the binder polymer (D).

The average particle diameter of the microcapsules is preferably 0.01 to 3.0 μm, more preferably 0.05 to 2.0 μm, still more preferably 0.10 to 1.0 μm. When the average particle diameter is in this range, excellent resolution and storability can be obtained.

<Surfactant>

In the invention, the image recording layer preferably includes a surfactant in order to improve on-press developability upon initiation of printing and to improve the surface property of the coated layer. The surfactant may be a nonionic surfactant, an anionic surfactant, a cationic surfactant, an amphoteric surfactant, or a fluorine-based surfactant. Only a single surfactant may be used, or two or more surfactants may be used.

The nonionic surfactant used in the invention is not particularly limited, and may be a conventionally known nonionic surfactant. Examples thereof include polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylene castor oils, polyoxyethylene glycerin fatty acid partial esters, fatty acid diethanol amides, N,N-bis-2-hydroxyalkyl amines, polyoxyethylene alkyl amine, triethanol amine fatty acid esters, trialkyl amine oxides, polyethylene glycol, and polyethylene glycol-polypropylene glycol copolymers.

The anionic surfactant used in the invention is not particularly limited, and may be a conventionally known anionic surfactant. Examples thereof include fatty acid salts, abietates, hydroxyalkane sulfonates, alkane sulfonates, dialkylsulfosuccinic ester salts, linear alkyl benzene sulfonates, branched alkyl benzene sulfonates, alkyl naphthalene sulfonates, alkyl phenoxy polyoxyethylene propyl sulfonates, polyoxyethylene alkyl sulfophenyl ether salts, N-methyl-N-oleyl taurine sodium salt, N-alkyl sulfosuccinic monoamide disodium salt, petroleum sulfonates, sulfated tallow oil, sulfuric ester salts of alkyl esters of fatty acids, alkyl sulfuric ester salts, polyoxyethylene alkyl ether sulfuric ester salts, fatty acid monoglyceride sulfuric ester salts, polyoxyethylene alkyl phenyl ether sulfuric ester salts, polyoxyethylene styryl phenyl ether sulfuric ester salts, alkyl phosphoric ester salts, polyoxyethylene alkyl ether phosphoric ester salts, polyoxyethylene alkyl phenyl ether phosphoric ester salts, partially saponified styrene-maleic anhydride copolymers, partially saponified olefin-maleic anhydride copolymers and naphthalene sulfonate formalin condensates.

The cationic surfactant used in the invention is not particularly limited, and may be a conventionally known cationic surfactant. Examples thereof include alkyl amine salts, quaternary ammonium salts, polyoxyethylene alkyl amine salts and polyethylene polyamine derivatives.

The amphoteric surfactant used in the invention is not particularly limited, and may be a conventionally known amphoteric surfactant. Examples thereof include carboxy betaines, aminocarboxylic acids, sulfobetaines, aminosulfates and imidazolines.

Examples of the surfactant further includes the surfactants obtained by replacing the polyoxyethylene in the above surfactants by a polyoxyalkylene such as a polyoxymethylene, a polyoxypropylene, or a polyoxybutylene.

Fluorine-based surfactants containing perfluoroalkyl groups are further preferable. Examples of the fluorine-based surfactants include: anionic surfactants such as perfluoroalkyl carboxylates, perfluoroalkyl sulfonates and perfluoroalkyl phosphates; amphoteric surfactants such as perfluoroalkyl betaine; cationic surfactants such as perfluoroalkyl trimethyl ammonium salts; and nonionic surfactants such as perfluoroalkyl amine oxides, perfluoroalkyl ethylene oxide adducts, oligomers each having a perfluoroalkyl group and a hydrophilic group, oligomers each having a perfluoroalkyl group and a lipophilic group, oligomers each having a perfluoroalkyl group, a hydrophilic group, and a lipophilic group, and urethanes each having a perfluoroalkyl group and a lipophilic group. The fluorine-based surfactants described in JP-A 62-170950, JP-A 62-226143 and JP-A 60-168144 (the disclosures of which are incorporated herein by reference) are also preferable.

Only a single surfactant may be used or two or more surfactants may be used. The content of the surfactant in the total solid of the image recording layer is preferably 0.001 to 10 wt %, more preferably 0.01 to 5 wt %.

<Colorant>

In the invention, various compounds other than the above-mentioned compounds may be further added if necessary. For example, dyes having large absorption in the visible light range can be used as colorants for an image. Specific examples of the colorants include Oil Yellow #101, Oil Yellow #103, Oil Pink #312, Oil Green BG, Oil Blue BOS, Oil Blue #603, Oil Black BY, Oil Black BS, Oil Black T-505 (which are manufactured by Orient Chemical Industries, Ltd.), Victoria Pure Blue, Crystal Violet (CI42555), Methyl Violet (CI42535), Ethyl Violet, Rhodamine B (CI145170B), Malachite Green (CI42000), Methylene Blue (CI52015), and the dyes disclosed in JP-A 62-293247 (the disclosure of which is incorporated herein by reference). The colorants are not limited to dyes and may be selected from pigments such as phthalocyanine pigments, azo pigments, carbon black and titanium oxide.

The addition of the colorants is preferable since the addition enables easy differentiation between the image region and the non-image region after image formation. The amount of the colorant to be added is 0.01 to 10% by weight based on the total solid of the image recording layer.

<Printing-Out Agent>

A compound whose color can be changed by an acid or by a radical may be added to the image recording layer in order to form a printout image. Such a compound may be, for example, a colorant such as a diphenyl methane colorant, a triphenyl methane colorant, a thiazine colorant, an oxazine colorant, a xanthene colorant, an anthraquinone colorant, an iminoquinone colorant, an azo colrant, or an azomethine colorant.

Specific examples thereof include dyes such as Brilliant Green, Ethyl Violet, Methyl Green, Crystal Violet, Basic Fuchsin, Methyl Violet 2B, Quinaldine Red, Rose Bengal, Metanil Yellow, Thymol Sulfophthalein, Xylenol Blue, Methyl Orange, Paramethyl Red, Congo Red, Benzopurprin 4B, α-Naphthyl Red, Nile Blue 2B, Nile Blue A, Methyl Violet, Malachite Green, Parafuchsin, Victoria Pure Blue BOH [manufactured by Hodogaya Kagaku Co., Ltd.], Oil Blue #603 [manufactured by Orient Chemical Industries, Ltd.], Oil Pink #312 [manufactured by Orient Chemical Industries, Ltd.], Oil Red 5B [manufactured by Orient Chemical Industries, Ltd.], Oil Scarlet #308 [manufactured by Orient Chemical Industries, Ltd.], Oil Red OG [manufactured by Orient Chemical Industries, Ltd.], Oil Red RR [manufactured by Orient Chemical Industries, Ltd.], Oil Green #502 [manufactured by Orient Chemical Industries, Ltd.], Spirone Red BEH Special [manufactured by Hodogaya Kagaku Co., Ltd.], m-Cresol Purple, Cresol Red, Rhodamine B, Rhodamine 6G Sulforhodamine B, Auramine, 4-p-diethylaminophenyl iminonaphthoquinone, 2-carboxyanilino-4-p-diethylaminophenyl iminonaphthoquinone, 2-carboxystearylamino-4-p-N,N-bis(hydroxyethyl) amino-phenyliminonaphthoquinone, 1-phenyl-3-methyl-4-p-diethylaminophenylimino-5-pyrazolone and 1-β-naphthyl-4-p-diethylaminophenylimino-5-pyrazolone, and leuco dyes such as p,p′,p″-hexamethyl triaminophenyl methane (Leuco Crystal Violet) and Pergascript Blue SRB (manufactured by Ciba-Geigy).

In addition to those described above, preferable examples of the printout agent further include leuco dyes known as materials for thermal sensitive paper and pressure sensitive paper. Specific examples thereof include crystal violet lactone, malachite green lactone, benzoyl leucomethylene blue, 2-(N-phenyl-N-methylamino)-6-(N-p-tolyl-N-ethyl) amino-fluoran, 2-anilino-3-methyl-6-(N-ethyl-p-toluidino) fluoran, 3,6-dimethoxy fluoran, 3-(N,N-diethylamino)-5-methyl-7-(N,N-dibenzylamino)-fluoran, 3-(N-cyclohexyl-N-methylamino)-6-methyl-7-anilinofluoran, 3-(N,N-diethylamino)-6-methyl-7-anilinofluoran, 3-(N,N-diethylamino)-6-methyl-7-xylidinofluoran, 3-(N,N-diethylamino)-6-methyl-7-chlorofluoran, 3-(N,N-diethylamino)-6-methoxy-7-aminofluoran, 3-(N,N-diethylamino)-7-(4-chloroanilino) fluoran, 3-(N,N-diethylamino)-7-chlorofluoran, 3-(N,N-diethylamino)-7-benzyl aminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-piperidino-6-methyl-7-anilinofluoran, 3-pyrrolidino-6-methyl-7-anilinofluoran, 3,3-bis(1-ethyl-2-methylindol-3-yl) phthalide, 3,3-bis(1-n-butyl-2-methylindol-3-yl) phthalide, 3,3-bis(p-dimethylaminophenyl)-6-dimethyl amino phthalide, 3-(4-diethylamino-2-ethoxyphenyl)-3-(1-ethyl-2-methylindol-3-yl)-4-phthalide, and 3-(4-diethylaminophenyl)-3-(1-ethyl-2-methylindol-3-yl) phthalide.

The amount of the dye whose color is changed by an acid or by a radical is 0.01 to 10 wt % based on the total weight of the solid in the image recording layer.

<Polymerization Inhibitor>

It is preferable to add a small amount of a heat-polymerization inhibitor to the image recording layer of the invention in order to inhibit undesired heat polymerization of the radical polymerizable compound (C) during the production or storage of the image recording layer.

Preferable examples of the heat-polymerization inhibitor include hydroquinone, p-methoxyphenol, di-t-butyl-p-cresol, pyrogallol, t-butyl catechol, benzoquinone, 4,4′-thiobis(3-methyl-6-t-butyl phenol), 2,2′-methylene bis(4-methyl-6-t-butyl phenol), and N-nitroso-N-phenyl hydroxylamine aluminum salt.

The amount of the heat-polymerization inhibitor to be added is preferably about 0.01 to about 5% by weight relative to the weight of the total solid of the image recording layer.

<Higher Fatty Acid Derivatives>

In order to prevent the polymerization inhibition by oxygen, a higher fatty acid derivative such as behenic acid or behenic amide may be added such that the higher fatty acid derivative is present on the surface of the image recording layer in the drying after the coating. The amount of the higher fatty acid derivative to be added is preferably about 0.1% by weight to about 10% by weight relative to the weight of the total solid of the image recording layer.

<Plasticizer>

In the invention, a plasticizer may be included in the image recording layer in order to improve on-press developability.

Preferable examples of the plasticizer include: phthalic esters such as dimethyl phthalate, diethyl phthalate, dibutyl phthalate, diisobutyl phthalate, dioctyl phthalate, octyl capryl phthalate, dicyclohexyl phthalate, ditridecyl phthalate, butyl benzyl phthalate, diisodecyl phthalate and diallyl phthalate; glycol esters such as dimethyl glycol phthalate, ethyl phthalyl ethyl glycolate, methyl phthalyl ethyl glycolate, butyl phthalyl butyl glycolate and triethylene glycol dicaprylate; phosphoric esters such as tricresyl phosphate and triphenyl phosphate; fatty dibasic acid esters such as diisobutyl adipate, dioctyl adipate, dimethyl sebacate, dibutyl sebacate, dioctyl azelate and dibutyl maleate; and polyglycidyl methacrylate, triethyl citrate, glycerin triacetyl ester and butyl laurate.

The content of the plasticizer is preferably about 30 wt % or less relative to the weight of the total solid of the image recording layer.

<Inorganic Fine Particles>

In the invention, the image recording layer may further include inorganic fine particles in order to improve the strength of the cured film in the image region and the on-press developability of the non-image region.

Examples of the inorganic fine particles include, for example, silica, alumina, magnesium oxide, titanium oxide, magnesium carbonate, calcium alginate and mixtures thereof. Even if an inorganic fine particle cannot convert light to heat, the inorganic fine particle may be used for reinforcement of the coating film and improvement of the interfacial adhesiveness by surface roughening.

The average particle diameter of the inorganic fine particle is preferably 5 nm to 10 μm, more preferably 0.5 μm to 3 μm. When the average particle diameter is in the above range, the inorganic fine particles can be dispersed stably in the image recording layer, whereby excellent film strength of the image recording layer is obtained and a highly hydrophilic non-image region which is hardly blemished during printing is obtained.

The inorganic fine particles described above are easily available as commercially available products such as colloidal silica dispersions. The content of the inorganic fine particles is preferably 40 wt % or lower, more preferably 30 wt % or lower, based on the weight of the total solid of the image recording layer.

<Low-Molecular Hydrophilic Compound>

In the invention, the image recording layer may further include a hydrophilic low-molecular compound in order to improve the on-press developability. The hydrophilic low-molecular compound may be a water-soluble organic compound. Examples thereof include: glycols such as ethylene glycol, diethylene glycol, triethylene glycol, propylene glycol, dipropylene glycol and tripropylene glycol, and ether derivatives thereof and ester derivatives thereof; polyhydroxy compounds such as glycerin and pentaerythritol; organic amines such as triethanol amine, diethanol amine, and monoethanol amine, and salts thereof; organic sulfonic acids such as toluene sulfonic acid and benzene sulfonic acid, and salts thereof; organic phosphonic acids such as phenyl phosphonic acid, and salts thereof; and organic carboxylic acids such as tartaric acid, oxalic acid, citric acid, malic acid, lactic acid, gluconic acid and amino acids, and salts thereof.

<Formation of the Image Recording Layer>

In the invention, the image recording layer is formed by dispersing or dissolving the necessary components described above in a solvent to prepare a coating liquid and then applying the coating liquid. Examples of the solvent include, but are not limited to: ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethyl urea, N-methylpyrrolidone, dimethyl sulfoxide, sulfolane, y-butyrolactone, toluene and water. Only a single solvent may be used or a mixture of two or more solvents may be used. The total solid content of the coating liquid is preferably 1 to 50% by weight.

In an embodiment, coating liquids each including different or overlapping components dissolved or dispersed in a same or different solvent are prepared, then the coating liquids are applied by the repetition of coating and drying to form the image recording layer.

The amount (in terms of the solid amount) of the image recording layer, which was formed on the support by coating and drying, may be changed in accordance with the intended use, and is preferably 0.3 to 3.0 g/m² in general. When the amount is in this range, an image recording layer with high sensitivity and excellent film properties can be obtained.

The coating may be conducted by any of various methods whose examples include bar coating, spin coating, spray coating, curtain coating, dip coating, air knife coating, blade coating and roll coating.

<Support>

The support used in the planographic printing plate precursor of the invention is not particularly limited insofar as it is a dimensionally stable plate. Examples thereof include a paper, a plastic laminated paper (e.g., polyethylene laminated paper, polypropylene laminated paper, polystyrene laminated paper etc.), a metal plate (e.g., aluminum, zinc, copper etc.), plastic film (e.g., cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal etc.), a paper on which any of the above-described metals is laminated or vapor-deposited, and a plastic film on which any of the above-described metals is laminated or vapor-deposited. The support is preferably a polyester film or an aluminum plate. The aluminum plate is particularly preferable because it is excellent in dimensional stability and relatively inexpensive.

The aluminum plate is preferably a pure aluminum plate or an alloy plate containing aluminum as the main component and trace amounts of heteroelements, or a plastic laminated aluminum thin film, or a plastic laminated aluminum alloy thin film. Examples of the heteroelements contained in the aluminum alloy include silicon, iron, manganese, copper, magnesium, chrome, zinc, bismuth, nickel, and titanium. The content of the heteroelements in the alloy is preferably 10% by weight or lower. Although a pure aluminum plate is preferable, production of absolutely pure aluminum is difficult from the viewpoint of refining techniques. The aluminum plate used in the invention may be an aluminum plated containing trace amounts of heteroelements. The composition of the aluminum plate is not limited, and any aluminum plates made of known and conventionally used material can be used in accordance with the necessity.

The thickness of the support is preferably 0.1 to 0.6 mm, more preferably 0.15 to 0.4 mm.

It is preferable to subject the aluminum plate to a surface treatment such as a roughening treatment or an anodizing treatment prior to use. By the surface treatment, hydrophilicity can be easily improved and the adhesion between the image recording layer and the support can be easily secured. Before the surface of the aluminum plate is roughened, the aluminum plate may be subjected to a degreasing treatment with e.g. a surfactant, an organic solvent or an aqueous alkali solution so as to remove the rolling oil, in accordance with the necessity.

Various methods can be employed for the roughening of the surface of the aluminum plate. For example, the roughening may be conducted by: a mechanical surface roughening, an electrochemical surface roughening (method of electrochemically dissolving the surface) or a chemical surface roughening (method of chemically and selectively dissolving the surface).

The mechanical surface roughening method may be a known method such as ball grinding, brush grinding, blast grinding, buff grinding, or the transfer method of transferring an embossed shape on an embossed roll to the aluminum plate during the rolling of aluminum.

The electrochemical roughening method may be a method of roughening the surface in an electrolysis solution containing hydrochloric acid or nitric acid with alternating current or direct current, or a method of using a mixed acid as described in JP-A 54-63902, the disclosure of which is incorporated by reference herein.

In an embodiment, the aluminum plate whose surface has been roughened is subjected to an alkali etching treatment with an aqueous solution of potassium hydroxide, sodium hydroxide, or the like, then to a neutralization treatment, then optionally to an anodizing treatment which improves the abrasion resistance.

The electrolyte used in the anodizing treatment of the aluminum plate may be selected from various electrolytes capable of forming a porous oxide film. Generally, the electrolyte is selected from sulfuric acid, hydrochloric acid, oxalic acid, chromic acid, or a mixed acid thereof. The concentration of the electrolyte is determined suitably in accordance with the type of the electrolyte.

The conditions for the anodizing treatment may be changed depending on the electrolyte and cannot be generalized. Usually, the concentration of the electrolyte is preferably 1 to 80% by weight, the liquid temperature is preferably 5 to 70° C., the current density is preferably 5 to 60 A/dm², the voltage is preferably 1 to 100 V, and the electrolysis time is preferably 10 seconds to 5 minutes. The amount of the anodized film is preferably 1.0 to 5.0 g/m², more preferably 1.5 to 4.0 g/m². When the amount of the anodized film is in this range, high printing durability and excellent flaw resistance of a non-image region of the planographic printing plate can be obtained.

<Sealing Treatment>

The support having an anodized film which has been subjected to the above surface treatments may be used as the support as it is. However, for the purpose of further improving adhesion to the upper layer, hydrophilicity, stain resistance, thermal insulating properties etc., the support may be further subjected to optional treatments such as: the treatment for enlarging micropores in the anodized film as described in JP-A 2001-253181 and JP-A 2001-322365, sealing treatment, and a surface hydrophilicity-imparting treatment in which the support is immersed in an aqueous solution containing a hydrophilic compound. The enlargement treatment and sealing treatment are not limited to the examples described above, and any known treatments can be conducted.

For example, the sealing treatment may be vapor sealing, a treatment only with fluorozirconic acid, a treatment with sodium fluoride, or vapor sealing involving addition of lithium chloride.

<Sealing Treatment>

The sealing treatment which can be conducted in the invention is not particularly limited, and may be conducted by a conventionally known method. The sealing treatment is preferably a sealing treatment with an aqueous solution containing an inorganic fluorine compound, a sealing treatment with water vapor, or a sealing treatment with hot water. Hereinafter, these methods are described respectively.

<Sealing Treatment with an Aqueous Solution Containing an Inorganic Fluorine Compound>

In a sealing treatment with an aqueous solution containing an inorganic fluorine compound, the inorganic fluorine compound used is preferably a metal fluoride.

Specific examples thereof include sodium fluoride, potassium fluoride, calcium fluoride, magnesium fluoride, sodium fluorozirconate, potassium fluorozirconate, sodium fluorotitanate, potassium fluorotitanate, ammonium fluorozirconate, ammonium fluorotitanate, potassium fluorotitanate, fluorozirconic acid, fluorotitanic acid, hexafluorosilicic acid, nickel fluoride, iron fluoride, fluorophosphoric acid and ammonium fluorophosphate. Preferable among these compounds are sodium fluorozirconate, sodium fluorotitanate, fluorozirconic acid and fluorotitanic acid.

The concentration of the inorganic fluorine compound in the aqueous solution is preferably 0.01 wt % or higher, more preferably 0.05 wt % or higher, in respect of sufficient sealing of micropores in the anodized film. The concentration of the inorganic fluorine compound in the aqueous solution is preferably 1 wt % or lower, more preferably 0.5 wt % or lower, in respect of stain resistance.

In a preferable embodiment, the aqueous solution containing an inorganic fluorine compound further contains a phosphate compound. When the phosphate compound is contained, the hydrophilicity of the surface of the anodized film is improved thus improving the on-press developability and the stain resistance.

The phosphate compound is preferably selected from metal phosphates such as phosphates of alkali metals and alkaline earth metals. Specific examples thereof include zinc phosphate, aluminum phosphate, ammonium phosphate, ammonium dihydrogen phosphate, ammonium dihydrogen phosphate, monoammonium phosphate, monopotassium phosphate, monosodium phosphate, potassium dihydrogen phosphate, dipotassium hydrogen phosphate, calcium phosphate, sodium ammonium hydrogen phosphate, magnesium hydrogen phosphate, magnesium phosphate, ferrous phosphate, ferric phosphate, sodium dihydrogen phosphate, sodium phosphate, disodium hydrogen phosphate, lead phosphate, diammonium phosphate, calcium dihydrogen phosphate, lithium phosphate, phosphotungstic acid, ammonium phosphotungstate, sodium phosphotungstate, ammonium phosphomolybdate, sodium phosphomolybdate, sodium phosphite, sodium tripolyphosphate and sodium pyrophosphate. Among these, sodium dihydrogen phosphate, disodium hydrogen phosphate, potassium dihydrogen phosphate and dipotassium hydrogen phosphate are preferable.

The combination of the inorganic fluorine compound and the phosphate compound is not particularly limited. In a preferable embodiment, the aqueous solution contains at least sodium fluorozirconate as the inorganic fluorine compound and at least sodium dihydrogen phosphate as the phosphate compound.

The concentration of the phosphate compound in the aqueous solution is preferably 0.01 wt % or higher, more preferably 0.1 wt % or higher, from the viewpoint of improving the on-press developability and the stain resistance. The concentration of the phosphate compound in the aqueous solution is preferably 20 wt % or lower, more preferably 5 wt % or lower, in respect of the solubility.

The ratio of the respective compounds in the aqueous solution is not particularly limited. The weight ratio of the inorganic fluorine compound to the phosphate compound is preferably 1/200 to 10/1, more preferably 1/30 to 2/1.

The temperature of the aqueous solution is preferably 20° C. or higher, more preferably 40° C. or higher, but preferably 100° C. or lower, more preferably 80° C. or lower.

The pH of the aqueous solution is preferably 1 or higher, more preferably 2 or higher, but preferably 11 or lower, more preferably 5 or lower.

The method of sealing using the aqueous solution containing an inorganic fluorine compound is not particularly limited, and examples thereof include a dipping method and a spraying method. Only a single kind of sealing treatment may be conducted or two or more kinds of sealing treatments may be conducted in combination. The sealing treatment may be conducted only once, or may be conducted for twice or more.

The dipping method is preferable for conducting the sealing treatment. When the dipping method is used in the treatment, the treatment time is preferably at least 1 second, more preferably at least 3 seconds, but preferably 100 seconds or shorter, more preferably 20 seconds or shorter.

<Sealing Treatment with Water Vapor>

The sealing treatment with water vapor may be conducted by, for example, allowing the anodized film to continuously or intermittently contact with pressurized water vapor or water vapor of atmospheric pressure.

The temperature of the water vapor is preferably 80° C. or higher, more preferably 95° C. or higher, but preferably 105° C. or lower.

The pressure of the water vapor is preferably in the range of from (atmospheric pressure—50 mmAq) to (atmospheric pressure+300 mmAq). In an embodiment, the pressure of the water vapor is preferably in the range of 1.008×10⁵ to 1.043×10⁵ Pa.

The water-vapor contact time is preferably 1 second or longer, more preferably 3 seconds or longer, but preferably 100 seconds or shorter, more preferably 20 seconds or shorter.

<Sealing Treatment with Hot Water>

The sealing treatment with hot water may be conducted, for example by dipping an aluminum plate having an anodized film formed thereon in hot water.

The hot water may include an inorganic salt (for example, a phosphate) or an organic salt. The temperature of the hot water is preferably 80° C. or higher, more preferably 95° C. or higher, but preferably 100° C. or lower. The dipping time is preferably 1 second or longer, more preferably 3 seconds or longer, but preferably 100 seconds or shorter, more preferably 20 seconds or shorter.

<The Hydrophilicity-Imparting Treatment>

The hydropilicity-imparting treatment may be an alkali metal silicate method described in U.S. Pat. Nos. 2,714,066, 3,181,461, 3,280,734 and 3,902,734, the disclosures of which are incorporated herein by reference. In this method, the support is dipped or electrolyzed in an aqueous solution of sodium silicate or the like. Other examples of the hydrophilicity-imparting treatment include a treatment with potassium fluorozirconate disclosed in JP-B 36-22063 and a treatment with polyvinyl phosphonic acid as disclosed in U.S. Pat. Nos. 3,276,868, 4,153,461, and 4,689,272.

When a support whose surface hydrophilicity is insufficient, such as polyester film, is used as the support in the invention, the surface is preferably made hydrophilic by being coated with a hydrophilic layer. The hydrophilic layer is preferably: a hydrophilic layer (described in JP-A 2001-199175, the disclosure of which is incorporated by reference herein) prepared by applying a coating liquid containing colloid of an oxide or hydroxide of at least one element selected from beryllium, magnesium, aluminum, silicon, titanium, boron, germanium, tin, zirconium, iron, vanadium, antimony and transition metals; a hydrophilic layer (described in JP-A 2002-79772, the disclosure of which is incorporated by reference herein) having an organic hydrophilic matrix obtained by crosslinking or pseudo-crosslinking an organic hydrophilic polymer; a hydrophilic layer having an inorganic hydrophilic matrix obtained by sol/gel conversion involving hydrolysis and condensation reaction of polyalkoxy silane, titanate, zirconate or aluminate; or a hydrophilic layer comprised of an inorganic thin film having a surface containing a metal oxide. Among these layers, a hydrophilic layer prepared by applying a coating liquid containing colloid of a silicon oxide or a silicon hydroxide is preferable.

When a polyester film or the like is used as the support in the invention, it is preferable to provide an antistatic layer to the hydrophilic layer side of the support and/or the side of the support opposite to the hydrophilic layer side. When an antistatic layer is arranged between the support and the hydrophilic layer, the antistatic layer can contribute also to the improvement of the adhesion of the hydrophilic layer. The antistatic layer may be, for example, a polymer layer in which a fine metallic oxide particle or a matting agent is dispersed, the polymer layer being described in JP-A 2002-79772 (the disclosure of which is incorporated by reference herein).

The center line average roughness of the support is preferably 0.10 to 1.2 μm. When the center line average roughness is in this range, excellent adhesion to the image recording layer, excellent printing durability and excellent stain resistance can be obtained.

<Back Coat Layer>

A back coat layer may be provided to the back side of the support after the support is subjected to a surface treatment or after the surface is provided with an undercoat layer.

The back coat is a layer preferably comprised of an organic polymer compound described in JP-A 5-45885 (the disclosure of which is incorporated herein by reference) or a metal oxide obtained by hydrolysis and polycondensation of organic or inorganic metal compounds described in JP-A 6-35174 (the disclosure of which is incorporated herein by reference). It is preferable to use silicon alkoxy compounds such as Si(OCH₃)₄, Si(OC₂H₅)₄, Si(OC₃H₇)₄ and Si(OC₄H₉)₄ because these starting materials are easily available and inexpensive.

<Undercoat Layer>

In the invention, an undercoat layer may be optionally provided between the image recording layer and the support. Because the undercoat layer functions as a thermal insulator layer, heat generated upon exposure to light from an infrared laser can be efficiently utilized without diffusing into the support, thus achieving higher sensitivity. In an unexposed region, the undercoat layer improves the on-press developability by facilitating release of the image recording layer from the support.

The undercoat layer material may be a silane coupling agent having an addition-polymerizable ethylenic double bond reactive group described in JP-A 10-282679 (the disclosure of which is incorporated herein by reference) and a phosphorus compound having an ethylenically double bond reactive group.

The coating amount (in terms of the solid content) of the undercoat layer is preferably 0.1 to 100 mg/m², more preferably 3 to 30 mg/m².

<Protective Layer>

In the invention, a protective layer may be optionally provided on the image recording layer for the purpose of prevention of the flaw on the image recording layer, oxygen blocking, and prevention of ablation upon exposure with a high-intensity laser.

In the invention, exposure is conducted usually in the air, and the protective layer prevents the incorporation of low-molecular compounds in the air (such as oxygen and basic substances) into the image recording layer, which low-molecular compounds inhibit the image formation reaction in the image recording layer caused by the exposure. In this manner, the protective layer prevents the inhibition of the image formation reaction in the air upon exposure to light. Accordingly, the protective layer preferably has a low permeability to a low-molecular compound such as oxygen. The protective layer preferably has a high transmittance to the light used in the exposure. The protective layer is preferably capable of adhering tightly to the image recording layer. The protective layer is preferably easily removable with the on-press development after the exposure. The protective layer having such properties has been extensively examined and described in detail in U.S. Pat. No. 3,458,311 and JP-A 55-49729, the disclosures of which are incorporated by reference herein.

The material used in the protective layer is preferably a water-soluble polymer compound having relatively high crystallinity. Specific examples thereof include water-soluble polymers such as polyvinyl alcohol, polyvinyl pyrrolidone, acidic celluloses, gelatin, gum arabic and polyacrylic acid. When polyvinyl alcohol (PVA) is used as a main component, the protective layer is optimal with respect to basic characteristics such as oxygen impermeability and removability upon development. The polyvinyl alcohol may be partially substituted by an ester, an ether or an acetal and may partially include other copolymerizable components insofar as it contains unsubstituted vinyl alcohol units which give the oxygen blocking property and water solubility required for the protective layer.

The polyvinyl alcohol may be a polyvinyl alcohol hydrolyzed at a degree of 71 to 100%, having a polymerization degree in the range of 300 to 2400. Specific examples thereof include PVA-105, PVA-110, PVA-117, PVA-117H, PVA-120, PVA-124, PVA-124H, PVA-CS, PVA-CST, PVA-HC, PVA-203, PVA-204, PVA-205, PVA-210, PVA-217, PVA-220, PVA-224, PVA-217EE, PVA-217E, PVA-220E, PVA-224E, PVA-405, PVA-420, PVA-613 and L-8, all of which are manufactured by Kuraray Co., Ltd.

The components (the kind of PVA and additives to be used) of the protective layer, the coating amount, etc. are selected in consideration of the oxygen blocking property, removability upon development, fogging property, adhesiveness, flaw resistance, and the like. In general, as the degree of hydrolysis of PVA is increased (as the content of unsubstituted vinyl alcohol units in the protective layer is increased) or as the thickness of the layer is increased, the oxygen blocking property is enhanced to improve the sensitivity. However, excessive oxygen blocking property is not preferred, which may result in undesired polymerization reaction during production or storage, and unnecessary fogging and line thickening upon imagewise exposure. Accordingly, the oxygen permeability A at 25° C. at 1 atm is preferably 0.2≦A≦20 (ml/m²·day).

As other components in the protective layer, glycerin, dipropylene glycol etc. can be added in an amount of a few wt % based on the (co)polymer, in order to impart flexibility to the protective layer. Further, anionic surfactants such as sodium alkylsulfate and sodium alkylsulfonate, amphoteric surfactants such as alkylaminocarboxylates and alkylaminodicarboxylates and nonionic surfactants such as polyoxyethylene alkyl phenyl ether may be added in an amount of a few wt % based on the (co)polymer.

The thickness of the protective layer is suitably 0.05 to 4 μm, particularly preferably 0.1 to 2.5 μm.

In addition, adhesion to the image region and flaw resistance are also very important in handling of the planographic printing plate precursor. That is, when the hydrophilic protective layer including a water-soluble polymer is laminated on the lipophilic image recording layer, the protective layer easily peels because of insufficient adhesion between the layers, so that defects such as insufficient film curing in the peeling portion occur because of the inhibition of the polymerization by oxygen.

Towards this problem, various proposals have been made for the purpose of improving the adhesion between the image recording layer and the protective layer. For example, JP-A 49-70702 and GB Patent Application (Laid-Open) No. 1303578 (the disclosures of which are incorporated herein by reference) disclose a method comprising incorporating an acrylic emulsion, a water-insoluble vinyl pyrrolidone-vinyl acetate copolymer, or the like in an amount of 20 to 60% by weight into a hydrophilic polymer primarily comprising polyvinyl alcohol and then laminating the mixture on the image recording layer thereby achieving satisfactory adhesion. Any known techniques can be used in the invention. The method for applying the protective layer is described in detail in e.g. U.S. Pat. No. 3,458,311 and JP-A 55-49729, the disclosures of which are incorporated by reference herein.

Further, the protective layer may have other functions. For example, when a colorant (for example, a water-soluble dye) which has high transmittance to infrared rays used for the exposure but efficiently absorbs lights of other wavelengths is added to the protective layer, the adaptability to safelight is improved without deteriorating the sensitivity.

(2) NIR (Recording Light Wavelength 760 to 1200 nm) Alkali Development Type Planographic Printing Plate

The basic constitution of the NIR alkali development type planographic printing plate is substantially identical to the constitution of the NIR on-press development type planographic printing plate described above, except that the binder polymers are different. The binder polymer to be used in the NIR alkali development type planographic printing plate is preferably a linear organic polymer, and may be a linear organic polymer soluble or swellable in water or weakly alkaline water. Particularly, a (meth)acrylic resin having a carboxyl group and a benzyl or allyl group on its side chain is preferable because the resultant printing plate has excellent balance with respect to the film strength, the sensitivity and the developability.

(3) UV (Recording Light Wavelength 250 To 420 Nm) On-Press Development Type Planographic Printing Plate

The constitution of the UV on-press development type planographic printing plate is substantially identical to the constitution of the NIR on-press development type planographic printing plate except that the infrared absorbing agent is not used UV on-press development type planographic printing plate. In the case of the UV on-press development type planographic printing plate, the polymerization initiator is preferably a triazine initiator, an organic halogen compound, an oxime ester compound, a diazonium salt, an iodonium salt, or a sulfonium salt, in respect of the reactivity and the safety.

It is preferable to use a combination of a sensitizer and a polymerization initiator selected from a triazine initiator, an organic halogen compound, an oxime ester compound, a diazonium salt, an iodonium salt or a sulfonium salt. By using the combination, the photopolymerization rate can be increased.

(4) Visible Alkali Development Type Planographic Printing Plate

The constitution of the visible alkali development type planographic printing plate is substantially identical to the constitution of the NIR alkali development type planographic printing plate except that the infrared absorbing agent is not used and a different polmerization initiator is used in the visible alkali development type planographic printing plate.

The polymerization initiator may be suitably selected from various polymerization initiators in accordance with the wavelength of the light source. It is also possible to use a suitable combination of two or more polymerization initiators (photo initiation systems) in accordance with the wavelength of the light source. For example, the initiation systems described in [0021] to [0023] of JP-A 2001-22079 (the disclosure of which is incorporated herein by reference) are preferable.

It is preferable to use a combination of a sensitizer and a polymerization initiator selected from a triazine initiator, an organic halogen compound, an oxime ester compound, a diazonium salt, an iodonium salt or a sulfonium salt. By using the combination, the photopolymerization rate can be increased.

Examples of the sensitizer include benzoin, benzoin methyl ether, benzoin ethyl ether, 9-fluorenone, 2-chloro-9-fluorenone, 2-methyl-9-fluorenone, 9-anthrone, 2-bromo-9-anthrone, 2-ethyl-9-anthrone, 9,10-anthraquinone, 2-ethyl-9, 10-anthraquinone, 2-t-butyl-9,10-anthraquinone, 2,6-dichloro-9,10-anthraquinone, xanthone, 2-methyl xanthone, 2-methoxy xanthone, thioxanthone, benzyl, dibenzal acetone, p-(dimethylamino)phenyl styryl ketone, p-(dimethylamino)phenyl p-methyl styryl ketone, benzophenone, p-(dimethylamino)benzophenone (or Michler's ketone), p-(diethylamino)benzophenone, and benzanthrone.

In the invention, the sensitizer is preferably a compound represented by the following formula (I) shown in JP-B 51-48516.

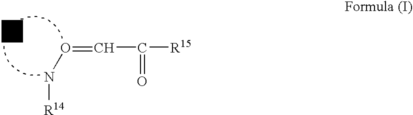

In the formula, R¹⁴ represents an alkyl group (for example, a methyl group, an ethyl group, a propyl group, or the like) or a substituted alkyl group (for example, a 2-hydroxyethyl group, a 2-methoxyethyl group, a carboxymethyl group, a 2-carboxyethyl group, or the like). R¹⁵ represents an alkyl group (for example, a methyl group, an ethyl group, or the like) or an aryl group (for example, a phenyl group, a p-hydroxyphenyl group, a naphthyl group, a thienyl group, or the like).

Z² represents a non-metallic atom group required for forming a heterocyclic nucleus containing nitrogen, the heterocyclic nucleus being usually used in a cyanine colorant. Examples of the heterocyclic nucleus include benzothiazoles (benzothiazole, 5-chlorobenzothiazole, 6-chlorobenzothiazole etc.), naphthothiazoles α-naphthothiazole, β-naphthothiazole etc.), benzoselenazoles (benzoselenazole, 5-chlorobenzoselenazole, 6-methoxybenzoselenazole etc.), naphthoselenazoles α-naphthoselenazole, β-naphthoselenazole etc.), benzoxazoles (benzoxazole, 5-methyl benzoxazole, 5-phenyl benzoxazole etc.) and naphthoxazoles α-naphthoxazole, β-naphthoxazole etc.).

An example of the compound represented by the formula (I) is specified by specifying Z², R¹⁴ and R¹⁵. There are many known compounds represented by the formula (I). The sensitizer may be suitably selected from the known compounds. Preferable examples of the sensitizer used in the invention also include merocyanine colorants described in JP-B 5-47095 and JP-A 2000-147763 (the disclosures of which are incorporated herein by reference) and ketocoumarin compounds represented by the following formula (II): 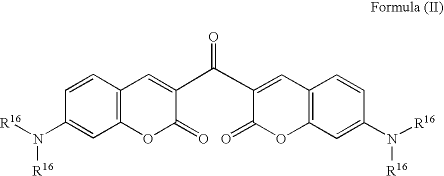
wherein R¹⁶ represents an alkyl group such as methyl group or ethyl group.

As the sensitizer, merocyanine colorants described in JP-A 2000-147763 can also be used. Specifically, the following compounds may be cited. 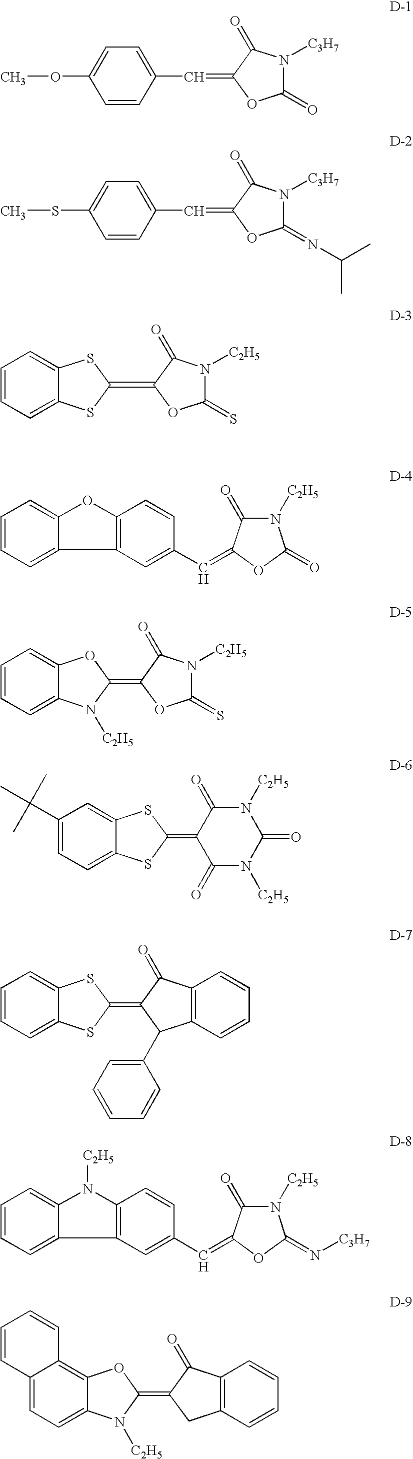
(4) Visible Alkali Development Type Planographic Printing Plate

The constitution of the visible alkali development type planographic printing plate is substantially identical to the constitution of the NIR alkali development type planographic printing plate except that the infrared absorbing agent is not used and a different polmerization initiator is used in the visible alkali development type planographic printing plate.

The polymerization initiator may be suitably selected from various polymerization initiators in accordance with the wavelength of the light source. It is also possible to use a suitable combination of two or more polymerization initiators (photo initiation systems) in accordance with the wavelength of the light source. For example, the initiation systems described in [0021] to [0023] of JP-A 2001-22079 (the disclosure of which is incorporated herein by reference) are preferable.

According to the exposure recording method of the invention for a planographic printing plate and the apparatus for practicing this method: the image recording layer on the support is irradiated with a predetermined amount of the first light, radical polymerization initiator molecules generate radical molecules; the generated radical molecules are quenched by the oxygen molecules in the image recording layer, thus the oxygen molecules in the image recording layer are consumed and exhausted, whereby the radical polymerization is prevented from being inhibited by oxygen; then the image recording layer is exposed to the second light (recording light) and the monomer in the recording layer initiates the radical polymerization immediately, and the chain reaction polymerization proceeds continuously to record an image.

In other words, in this method, the first light works as a replacement for the part of the recording light (second light) which could not be used for exposure because of the existence of oxygen in the image recording layer if the irradiation with the first light were not conducted. In this manner, the image recording layer of the planographic printing plate is supersensitized.

1. A method of light exposure recording on a planographic printing plate,
wherein the planographic printing plate includes a support and an image recording layer provided on the support, the image recording layer includes a radical polymerization initiator, and the image recording layer utilizes a photo-radical polymerization reaction for image formation,
the method comprising:
irradiating the image recording layer with a predetermined amount of a first light, whereby the radical initiator generates a radical, and the radical is quenched by free oxygen in the image recording layer, so that the free oxygen in the image recording layer is exhausted and disappears from the image recording layer and so that the image recording layer is supersensitized; and then
irradiating the image recording layer with a second light as a recording light modulated on the basis of image information, so as to form a latent image corresponding to the image information on the image recording layer.

2. The method according to claim 1, wherein a light source of the first light is an infrared lamp.

3. The method according to claim 1, wherein a light source of the first light is a xenon lamp.

4. The method according to claim 1, wherein a light source of the second light is an infrared laser light.

5. The method according to claim 1, further comprising irradiating a region of the image recording layer with a third light such that the third light causes the radical polymerization initiator to generate a number of radicals which is nearly the same as the number of radicals that oxygen molecules newly entering the image recording layer can quench,
wherein the region is a region which has just been exposed and in which the radical polymerization reaction is still in progress.

6. An apparatus for exposure recording on a planographic printing plate, the apparatus comprising a pre-exposure lighting device and an exposure head,
wherein:
the planographic printing plate includes a support and an image recording layer provided on the support, and the image recording layer utilizes a photo-radical polymerization reaction for image formation and includes a radical polymerization initiator;
the pre-exposure lighting device radiates a predetermined amount of a first light to the image recording layer, the predetermined amount of the first light causes the radical polymerization initiator to generate a radical, and oxygen in the image recording layer quenches the radical and is consumed, so that free oxygen disappears from the image recording layer and so that the image recording layer is supersensitized;
the exposure head radiates a second light as a recording light modulated on the basis of image information to the supersensitized image recording layer, whereby a latent image corresponding to the image information is formed on the image recording layer.

7. The apparatus according to claim 6, wherein the apparatus has a cylindrical outer drum which can hold the planographic printing plate and which can be rotated, the planographic printing plate can be attached to the cylindrical outer drum and can be detached from the cylindrical outer drum, and the planographic printing plate when attached to the cylindrical outer drum can be moved in a main scanning direction by rotation of the cylindrical outer drum.

8. The apparatus according to claim 6, wherein the pre-exposure lighting device has an irradiation head capable of uniformly irradiating a predetermined region of the image recording layer with the first light immediately before exposure of the predetermined region.

9. The apparatus according to claim 8, wherein the apparatus has a cylindrical outer drum which can hold the planographic printing plate and which can be rotated, the planographic printing plate can be attached to the cylindrical outer drum and can be detached from the cylindrical outer drum, and the planographic printing plate when attached to the cylindrical outer drum can be moved in a main scanning direction by rotation of the cylindrical outer drum.

10. The apparatus according to claim 9, wherein the irradiation head and the exposure head can be moved in a sub scanning direction.

11. The apparatus according to claim 8, wherein the irradiation head is connected via an optical fiber to a light source.

12. The apparatus according to claim 6, wherein a light source of the pre-exposure lighting device is an infrared lamp.

13. The apparatus according to claim 6, wherein a light source of the pre-exposure lighting device is a xenon lamp.

14. The apparatus for exposure recording on a planographic printing plate of claim 6, wherein the second light is infrared laser light.

15. The apparatus according to claim 6, wherein the pre-exposure lighting device has an irradiation head capable of irradiating an entire surface of the image recording layer, the irradiation head can uniformly irradiate an area which covers an entire width of the image recording layer, and the width of the image recording layer is perpendicular to a main scanning direction.

16. The apparatus according to claim 15, wherein the irradiation head is connected via an optical fiber to a light source.

17. The apparatus according to claim 16, wherein the light source of the irradiation head is an infrared lamp.

18. The apparatus according to claim 16, wherein the light source of the irradiation head is a xenon lamp.

19. The apparatus according to claim 15, wherein the irradiation head is constituted so as to irradiate a region of the image recording layer with a third light such that the third light causes the radical polymerization initiator to generate a number of radicals which is nearly the same as the number of radicals that oxygen molecules newly entering the image recording layer can quench, the region being a region which has just been exposed and in which the radical polymerization reaction is still in progress.
